(19) United States
(12) Patent Application Publication
(10) Pub. No.: US 2026/0247228 A1
(43) Pub. Date: Aug. 20, 2026

(54) TIMING SYNCHRONIZATION DURING HANDOVER PROCEDURES IN WIRELESS COMMUNICATIONS

(71) Applicant: QUALCOMM Incorporated, San Diego, CA (US)

(72) Inventors: Naeem AKL, San Jose, CA (US); Navid ABEDINI, Basking Ridge, NJ (US); Jianghong LUO, Skillman, NJ (US); Meilong JIANG, Westfield, NJ (US); Ahmed BEDEWY, Hillsborough, NJ (US)

(21) Appl. No.: 19/056,527

(22) Filed: Feb. 18, 2025

(51) Int. Cl. H04W 36/00; H04W 64/00

(52) U.S. Cl. CPC H04W 36/0072; H04W 36/0077; H04W 64/003

(57) ABSTRACT

Methods, systems, and devices for wireless communications are described. In some examples, a relay user equipment (UE) may forward, from a first network entity to a remote UE in communication with the relay UE, a control message indicating that the remote UE is to perform a procedure with a second network entity. In such examples, the relay UE may obtain, in accordance with forwarding the control message to the remote UE, timing advance information used for communications between the second network entity and the remote UE. Accordingly, the relay UE may transmit the timing advance information to the remote UE, where the remote UE may utilize the timing advance information to communicate with the second network entity.

### FIELD OF TECHNOLOGY

The following relates to wireless communications, including timing synchronization during handover procedures in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a relay user equipment (UE) is described. The method may include forwarding, from a first network entity to a remote UE in communication with the relay UE, a control message indicating that the remote UE is to perform a procedure with a second network entity, obtaining, in accordance with forwarding the control message to the remote UE, timing advance (TA) information used for communications between the second network entity and the remote UE, and transmitting the TA information to the remote UE in accordance with obtaining the TA information.

A relay UE for wireless communications is described. The relay UE may include one or more memories storing processor executable code, and one or more processors coupled with the one or more memories. The one or more processors may individually or collectively be operable to execute the code to cause the relay UE to forwarding, from a first network entity to a remote UE in communication with the relay UE, a control message indicate that the remote UE is to perform a procedure with a second network entity, obtain, in accordance with forwarding the control message to the remote UE, TA information used for communications between the second network entity and the remote UE, and transmit the TA information to the remote UE in accordance with obtaining the TA information.

Another relay UE for wireless communications is described. The relay UE may include means for forwarding, from a first network entity to a remote UE in communication with the relay UE, a control message indicating that the remote UE is to perform a procedure with a second network entity, means for obtaining, in accordance with forwarding the control message to the remote UE, TA information used for communications between the second network entity and the remote UE, and means for transmitting the TA information to the remote UE in accordance with obtaining the TA information.

A non-transitory computer-readable medium storing code for wireless communications is described. The code may include instructions executable by one or more processors to forwarding, from a first network entity to a remote UE in communication with the relay UE, a control message indicate that the remote UE is to perform a procedure with a second network entity, obtain, in accordance with forwarding the control message to the remote UE, TA information used for communications between the second network entity and the remote UE, and transmit the TA information to the remote UE in accordance with obtaining the TA information.

In some examples of the method, relay UEs, and non-transitory computer-readable medium described herein, the procedure may be a handover procedure, and the control message further indicates that the remote UE may be to perform the handover procedure to the second network entity without communicating a first random-access message and a second random-access message of a random-access channel (RACH) procedure.

In some examples of the method, relay UEs, and non-transitory computer-readable medium described herein, obtaining the TA information may include operations, features, means, or instructions for computing a first TA value associated with communications between the relay UE and the second network entity, where the TA information includes an indication of the first TA value, location information associated with the relay UE, or both.

Some examples of the method, relay UEs, and non-transitory computer-readable medium described herein may further include operations, features, means, or instructions for receiving one or more first reference signals from the first network entity and receiving one or more second reference signals from the second network entity, where computing the first TA value may be in accordance with the one or more first reference signals, the one or more second reference signals, a second TA value associated with communications between the relay UE and the first network entity, or any combination thereof.

Some examples of the method, relay UEs, and non-transitory computer-readable medium described herein may further include operations, features, means, or instructions for obtaining a second TA value associated with communications between the remote UE and the second network entity in accordance with an adjustment of the first TA value using the location information of the remote UE, measurement information of the remote UE, or both, where the TA information includes the second TA value.

Some examples of the method, relay UEs, and non-transitory computer-readable medium described herein may further include operations, features, means, or instructions for receiving assistance information from the remote UE, where the assistance information includes the location information of the remote UE, the measurement information of the remote UE, or both.

Some examples of the method, relay UEs, and non-transitory computer-readable medium described herein may further include operations, features, means, or instructions for obtaining a first TA value used for communications between the relay UE and the second network entity, where the TA information includes the first TA value.

In some examples of the method, relay UEs, and non-transitory computer-readable medium described herein, the first TA value is obtained from the first network entity, obtained from the second network entity, obtained in accordance with communication of a first message from the relay UE to the second network entity, or any combination thereof.

In some examples of the method, relay UEs, and non-transitory computer-readable medium described herein, the TA information includes a first reception time at the relay UE of a first reference signal from the first network entity, a second reception time at the relay UE of a second reference signal from the second network entity, a first TA value used for communications between the relay UE and the first network entity, location information of the relay UE, or any combination thereof.

In some examples of the method, relay UEs, and non-transitory computer-readable medium described herein, forwarding the control message may include operations, features, means, or instructions for receiving, from the first network entity, a trigger for the remote UE to perform the early random-access procedure with the second network entity and transmitting, to the remote UE, the trigger for the remote UE to perform the early random-access procedure with the second network entity, where obtaining the TA information may be in accordance with transmitting the trigger for the remote UE to perform the early random-access procedure.

In some examples of the method, relay UEs, and non-transitory computer-readable medium described herein, obtaining the TA information may include operations, features, means, or instructions for receiving, from the first network entity, an indication of the TA information, where transmitting the TA information is in accordance with receiving the indication.

A method for wireless communications by a remote UE is described. The method may include receiving, from a first network entity via a relay UE, a control message indicating that the remote UE is to perform a procedure with a second network entity, obtaining, in accordance with receiving the control message, TA information used for communications between the second network entity and the remote UE, and communicating with the second network entity according to the TA information.

A remote UE for wireless communications is described. The remote UE may include one or more memories storing processor executable code, and one or more processors coupled with the one or more memories. The one or more processors may individually or collectively be operable to execute the code to cause the remote UE to receive, from a first network entity via a relay UE, a control message indicating that the remote UE is to perform a procedure with a second network entity, obtain, in accordance with receiving the control message, TA information used for communications between the second network entity and the remote UE, and communicate with the second network entity according to the TA information.

Another remote UE for wireless communications is described. The remote UE may include means for receiving, from a first network entity via a relay UE, a control message indicating that the remote UE is to perform a procedure with a second network entity, means for obtaining, in accordance with receiving the control message, TA information used for communications between the second network entity and the remote UE, and means for communicating with the second network entity according to the TA information.

A non-transitory computer-readable medium storing code for wireless communications is described. The code may include instructions executable by one or more processors to receive, from a first network entity via a relay UE, a control message indicating that the remote UE is to perform a procedure with a second network entity, obtain, in accordance with receiving the control message, TA information used for communications between the second network entity and the remote UE, and communicate with the second network entity according to the TA information.

In some examples of the method, remote UEs, and non-transitory computer-readable medium described herein, the procedure may be a handover procedure, and the control message further indicates that the remote UE may be to perform the handover procedure to the second network entity without communicating a first random-access message and a second random-access message of a RACH procedure.

In some examples of the method, remote UEs, and non-transitory computer-readable medium described herein, the TA information includes a first reception time at the relay UE of a first reference signal from the first network entity and the method, apparatuses, and non-transitory computer-readable medium may include further operations, features, means, or instructions for computing a TA value used for communications between the remote UE and the second network entity using the TA information.

In some examples of the method, remote UEs, and non-transitory computer-readable medium described herein, the TA information includes a first TA used for communications between the relay UE and the second network entity and the method, apparatuses, and non-transitory computer-readable medium may include further operations, features, means, or instructions for obtaining a second TA according to an adjustment of the first TA using location information of the remote UE, measurement information of the remote UE, or both.

In some examples of the method, remote UEs, and non-transitory computer-readable medium described herein, the procedure may be an early random-access procedure between the remote UE and the second network entity and the method, apparatuses, and non-transitory computer-readable medium may include further operations, features, means, or instructions for receiving, from the relay UE via the control message, a trigger to perform the early random-access procedure with the second network entity and transmitting, via a RACH resource and as part of the early random-access procedure, a first random-access message to the second network entity, where obtaining the TA information is in accordance with transmitting the first random-access message.

A method for wireless communications by a first network entity is described. The method may include receiving, from a second network entity, a request for a remote UE to perform a handover procedure to the first network entity, where the remote UE is in communication with the second network entity via a relay UE, and where the request includes an indication of the relay UE, transmitting, to the second network entity, a control message indicating that the remote UE is to perform the handover procedure to the first network entity without communicating a first random-access message and a second random-access message of a RACH procedure, and communicating, in accordance with transmitting the control message, with the remote UE according to a TA value.

A first network entity for wireless communications is described. The first network entity may include one or more memories storing processor executable code, and one or more processors coupled with the one or more memories. The one or more processors may individually or collectively be operable to execute the code to cause the first network entity to receive, from a second network entity, a request for a remote UE to perform a handover procedure to the first network entity, where the remote UE is in communication with the second network entity via a relay UE, and where the request includes an indication of the relay UE, transmit, to the second network entity, a control message indicating that the remote UE is to perform the handover procedure to the first network entity without communicating a first random-access message and a second random-access message of a RACH procedure, and communicate, in accordance with transmitting the control message, with the remote UE according to a TA value.

Another first network entity for wireless communications is described. The first network entity may include means for receiving, from a second network entity, a request for a remote UE to perform a handover procedure to the first network entity, where the remote UE is in communication with the second network entity via a relay UE, and where the request includes an indication of the relay UE, means for transmitting, to the second network entity, a control message indicating that the remote UE is to perform the handover procedure to the first network entity without communicating a first random-access message and a second random-access message of a RACH procedure, and means for communicating, in accordance with transmitting the control message, with the remote UE according to a TA value.

A non-transitory computer-readable medium storing code for wireless communications is described. The code may include instructions executable by one or more processors to receive, from a second network entity, a request for a remote UE to perform a handover procedure to the first network entity, where the remote UE is in communication with the second network entity via a relay UE, and where the request includes an indication of the relay UE, transmit, to the second network entity, a control message indicating that the remote UE is to perform the handover procedure to the first network entity without communicating a first random-access message and a second random-access message of a RACH procedure, and communicate, in accordance with transmitting the control message, with the remote UE according to a TA value.

Some examples of the method, first network entities, and non-transitory computer-readable medium described herein may further include operations, features, means, or instructions for receiving, via a RACH resource and as part of an early random-access procedure, a first random-access message from the remote UE, where receiving the request for the remote UE to perform the handover procedure may be in accordance with receiving the first random-access message, and where the early random-access procedure is performed prior to the handover procedure and transmitting, to the second network entity, the TA value, where the TA value may be computed in accordance with receiving the first random-access message from the remote UE.

In some examples of the method, first network entities, and non-transitory computer-readable medium described herein, the TA value may be transmitted via the control message, or the TA value may be transmitted in a second control message that may be different from the control message.

Some examples of the method, first network entities, and non-transitory computer-readable medium described herein may further include operations, features, means, or instructions for receiving, via a RACH resource and as part of an early random-access procedure, a first random-access message from the remote UE and transmitting, to the remote UE and as part of the early random-access procedure, the TA value, where the TA value is computed in accordance with receiving the first random-access message from the remote UE, where receiving the request for the remote UE to perform the handover procedure may be in response to transmitting the TA value to the second network entity, and where the early random-access procedure may be performed prior to the handover procedure

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports timing synchronization during handover procedures in wireless communications in accordance with one or more aspects of the present disclosure.

FIG. 2 shows an example of a wireless communications system that supports timing synchronization during handover procedures in wireless communications in accordance with one or more aspects of the present disclosure.

FIG. 3 shows an example of a process flow that supports timing synchronization during handover procedures in wireless communications in accordance with one or more aspects of the present disclosure.

FIG. 4 shows an example of a process flow that supports timing synchronization during handover procedures in wireless communications in accordance with one or more aspects of the present disclosure.

FIG. 5 shows an example of a wireless communications system that supports timing synchronization during handover procedures in wireless communications in accordance with one or more aspects of the present disclosure.

FIG. 6 shows an example of a wireless communications system that supports timing synchronization during handover procedures in wireless communications in accordance with one or more aspects of the present disclosure.

FIG. 7 shows an example of a wireless communications system that supports timing synchronization during handover procedures in wireless communications in accordance with one or more aspects of the present disclosure.

FIG. 8 shows an example of a wireless communications system that supports timing synchronization during handover procedures in wireless communications in accordance with one or more aspects of the present disclosure.

FIG. 9 shows an example of a wireless communications system that supports timing synchronization during handover procedures in wireless communications in accordance with one or more aspects of the present disclosure.

FIGS. 10 and 11 show block diagrams of devices that support timing synchronization during handover procedures in wireless communications in accordance with one or more aspects of the present disclosure.

FIG. 12 shows a block diagram of a communications manager that supports timing synchronization during handover procedures in wireless communications in accordance with one or more aspects of the present disclosure.

FIG. 13 shows a diagram of a system including a device that supports timing synchronization during handover procedures in wireless communications in accordance with one or more aspects of the present disclosure.

FIGS. 14 and 15 show block diagrams of devices that support timing synchronization during handover procedures in wireless communications in accordance with one or more aspects of the present disclosure.

FIG. 16 shows a block diagram of a communications manager that supports timing synchronization during handover procedures in wireless communications in accordance with one or more aspects of the present disclosure.

FIG. 17 shows a diagram of a system including a device that supports timing synchronization during handover procedures in wireless communications in accordance with one or more aspects of the present disclosure.

FIGS. 18 through 20 show flowcharts illustrating methods that support timing synchronization during handover procedures in wireless communications in accordance with one or more aspects of the present disclosure.

### DETAILED DESCRIPTION

In some wireless communications systems, a user equipment (UE) may support handover procedures between a source network entity and a target network entity without communicating one or more messages of a random-access channel (RACH) procedure (e.g., a RACH-less handover). For example, in a RACH-less handover, the UE may receive, from the source network entity, a message indicating for the UE to perform the RACH-less handover, where the message may further include a timing advance (TA) value that is to be used for the RACH-less handover procedure with the target network entity. In such cases, the TA value may be equal to zero or be set to the TA value used for communications with the source network entity. Accordingly, the UE may perform the RACH-less handover procedure using the TA indicated in the message. In this way, the UE and the target network entity may reduce latency associated with the handover procedure.

In some cases, the UE may communicate with the source network entity via a relay UE, where the UE may be referred to as a remote UE. To facilitate handover procedures at the remote UE, the remote UE and the target network entity may perform a RACH procedure to begin communications. Accordingly, it may be beneficial for the remote UE to perform the RACH-less handover procedure with the target network entity to reduce latency associated with handover procedures. In such cases, however, the remote UE may be unable to obtain a TA value for the RACH-less handover procedure, which may prohibit the remote UE from performing the RACH-less handover procedure. For example, because the remote UE communicates with the source network entity via the relay UE, the remote UE may not have a TA value associated with the source network entity, which may prohibit the TA value associated with the target network entity from being set to the source TA value. Additionally, a TA value set to zero may not be feasible, for example, due to a distance between the target network entity and the remote UE. Thus, techniques may be desired to indicate a TA value to the remote UE for use during RACH-less handover procedures.

The techniques, methods, and devices described herein enable the remote UE to receive a TA value associated with the target network entity, thereby enabling the remote UE to perform a RACH-less handover procedure to the target network entity. In some examples, the relay UE may provide, to the remote UE, TA information associated with communications between the remote UE and the target network entity. In such examples, the TA information may include a TA value computed by the relay UE, include a TA value computed by the source and/or target network entities, or include one or more parameters that the remote UE can use to compute the TA value. As such, the remote UE may utilize the TA information received from the relay UE to obtain a TA value for communications with the target network entity. In some other examples, the relay UE may indicate for the remote UE to perform an early RACH procedure towards the target network entity, such that the remote UE may obtain a TA value for communications with the target network entity via the early RACH procedure. As described herein, an early RACH procedure may involve communication of one or more messages of a RACH procedure prior to a handover request.

Aspects of the disclosure are initially described in the context of wireless communications systems. Aspects of the disclosure are illustrated in the context of process flows. Aspects of the disclosure are further illustrated by and described with reference to apparatus diagrams, system diagrams, and flowcharts that relate to timing synchronization during handover procedures in wireless communications.

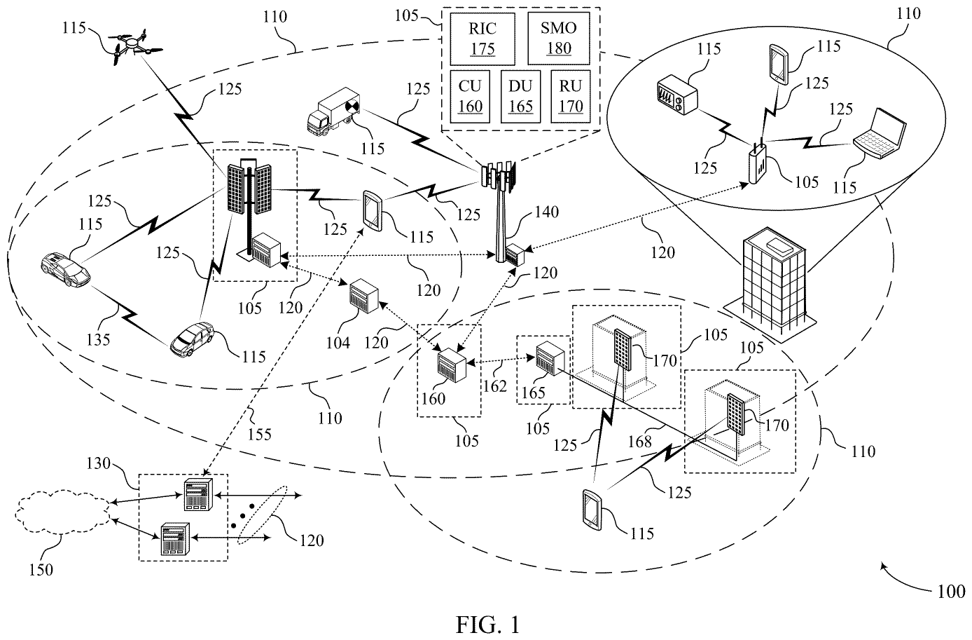

FIG. 1 shows an example of a wireless communications system 100 that supports timing synchronization during handover procedures in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support timing synchronization during handover procedures in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a UE 115 may support handover procedures between a source network entity 105 and a target network entity 105 without communicating one or more messages of a RACH procedure (e.g., a RACH-less handover). For example, in a RACH-less handover, the UE 115 may receive, from the source network entity 105, a message indicating for the UE 115 to perform the RACH-less handover, where the message may further include a TA value that is to be used for the RACH-less handover procedure with the target network entity 105. In such cases, the TA value may be equal to zero or be set to the TA value used for communications with the source network entity 105. Accordingly, the UE 115 may perform the RACH-less handover procedure using the TA indicated in the message. In this way, the UE 115 and the target network entity 105 may reduce latency associated with the handover procedure.

In some cases, the UE 115 may communicate with the source network entity 105 via a relay UE 115, where the UE 115 may be referred to as a remote UE 115. To facilitate handover procedures at the remote UE 115, the remote UE 115 and the target network entity 105 may perform a RACH procedure to begin communications. Accordingly, it may be beneficial for the remote UE 115 to perform the RACH-less handover procedure with the target network entity 105 to reduce latency associated with handover procedures. In such cases, however, the remote UE 115 may be unable to obtain a TA value for the RACH-less handover procedure, which may prohibit the remote UE 115 from performing the RACH-less handover procedure. For example, because the remote UE 115 communicates with the source network entity 105 via the relay UE 115, the remote UE 115 may not have a TA value associated with the source network entity 105, which may prohibit the TA value associated with the target network entity 105 from being set to the source TA value. Additionally, a TA value set to zero may not be feasible, for example, due to a distance between the target network entity 105 and the remote UE 115. Thus, techniques may be desired to indicate a TA value to the remote UE 115 for use during RACH-less handover procedures.

The techniques, methods, and devices described herein enable the remote UE 115 to receive a TA value associated with the target network entity 105, thereby enabling the remote UE 115 to perform a RACH-less handover procedure to the target network entity 105. In some examples, the relay UE 115 may provide, to the remote UE 115, TA information associated with communications between the remote UE 115 and the target network entity 105. In such examples, the TA information may include a TA value computed by the relay UE 115, include a TA value computed by the source and/or target network entities, or include one or more parameters that the remote UE 115 can use to compute the TA value. As such, the remote UE 115 may utilize the TA information received from the relay UE 115 to obtain a TA value for communications with the target network entity 105. In some other examples, the relay UE 115 may indicate for the remote UE 115 to perform an early RACH procedure towards the target network entity 105, such that the remote UE 115 may obtain a TA value for communications with the target network entity 105 via the early RACH procedure. As described herein, an early RACH procedure may involve communication of one or more messages of a RACH procedure prior to a handover request.

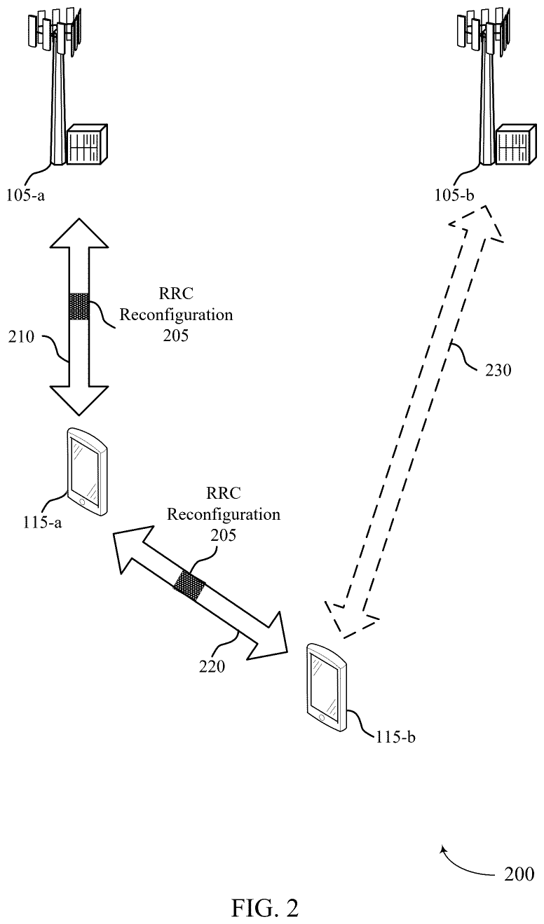

FIG. 2 shows an example of a wireless communications system 200 that supports timing synchronization during handover procedures in wireless communications in accordance with one or more aspects of the present disclosure. Aspects of the wireless communications system 200 may implement, or be implemented by, the wireless communications system 100. For example, the wireless communications system 200 may include a network entity 105-a (e.g., a source network entity, a source cell), a network entity 105-b (e.g., a target network entity, a target cell), a UE 115-a (e.g., a relay UE), and a UE 115-b (e.g., a remote UE), each of which may represent examples of corresponding devices described herein with reference to FIG. 1. The techniques described in the context of the wireless communications system 200 may enable the UE 115-b to perform a RACH-less handover to the network entity 105-b.

The UE 115-b may communicate with the network entity 105-a via the UE 115-a. To facilitate such communications, the UE 115-a may establish a Uu link 210 with the network entity 105-a and establish a sidelink 220 with the UE 115-b. In this way, the UE 115-a may establish an indirect data path for the UE 115-b. In some cases, the UE 115-b may provide, to the network entity 105-a (e.g., to a DU and CU associated with the network entity 105-a) via the UE 115-a, measurement reports associated with one or more target network entities (e.g., including the network entity 105-b) according to one or more measurement configurations. In such cases, the network entity 105-a (e.g., the CU associated with the network entity 105-a) may determine that the UE 115-b is to perform a handover procedure to the one of the target network entities, such as the network entity 105-b, according to the measurement reports. In such examples, the handover may be an indirect to direct path switch (e.g., switch from communicating via the sidelink 220 to communicating via a Uu link 230).

To facilitate such handovers, the network entity 105-a (e.g., the CU associated with the network entity 105-a) may transmit a handover request to the network entity 105-b (e.g., the CU associated with the network entity 105-b). In response, a CU of the network entity 105-b may create and indicate a UE context setup for the UE 115-b to the DU of network entity 105-b. Based on creating the UE context, the network entity 105-b (e.g., the CU associated with the network entity 105-b) may transmit a handover request acknowledgement that includes an RRC reconfiguration 205 to the network entity 105-a (e.g., the CU associated with the network entity 105-a). A CU of the network entity 105-a may transmit a UE context modification request to a DU of the network entity 105-a, where the request may include the RRC reconfiguration 205. In some examples, the DU of the network entity 105-a may transmit a UE context modification response to the CU of the network entity 105-a

The network entity 105-a (e.g., the DU associated with the network entity 105-a) may forward the RRC reconfiguration 205 to the UE 115-a, where the UE 115-a may forward the RRC reconfiguration 205 to the UE 115-b, which may trigger the UE 115-b to perform a handover procedure to the network entity 105-b. In such cases, the UE 115-b may perform the handover procedure to the network entity 105-b via a RACH based procedure. For example, the UE 115-b and the network entity 105-b may perform the RACH procedure (e.g., transmit message 1 (MSG1), message 2 (MSG2), message 3 (MSG 3) and message 4 (MSG 4)), such that the UE 115-b may connect to the network entity 105-b. In response to the completion of the RACH procedure, the UE 115-b may transmit an RRC reconfiguration complete message to the network entity 105-b (e.g., the DU associated with the network entity 105-b), where the DU of the network entity 105-b may transmit an uplink RRC message transfer message to the CU of the network entity 105-b. Subsequently, the CU of the network entity 105-b may transmit, to the CU of the network entity 105-a, a UE context release message, where the CU and DU of the network entity 105-a may release the context associated with the UE 115-b.

In some cases, a UE 115 (not shown) may support a RACH-less based handover procedure for direct-to-direct path switches (e.g., switching from a first Uu link to a second Uu link). For example, the UE 115 may communicate with the network entity 105-a via a first Uu link. In such cases, the UE 115 may provide, to the network entity 105-a (e.g., to a DU and CU associated with the network entity 105-a), measurement reports associated with one or more target network entities (e.g., including the network entity 105-b) according to one or more measurement configurations. In such cases, the network entity 105-a (e.g., the CU associated with the network entity 105-a) may determine that the UE 115 is to perform a handover procedure to the one of the target network entities, such as the network entity 105-b, according to the measurement reports.

To facilitate such handovers (e.g., direct-to-direct handovers), the network entity 105-a (e.g., the CU associated with the network entity 105-a) may transmit a handover request to the network entity 105-b (e.g., the CU associated with the network entity 105-b). In response, a CU of the network entity 105-b may create and indicate a UE context setup for the UE 115 to the DU of network entity 105-b. Based on creating the UE context, the network entity 105-b (e.g., the CU associated with the network entity 105-b) may transmit a handover request acknowledgement that includes an RRC reconfiguration 205 to the network entity 105-a (e.g., the CU associated with the network entity 105-a). A CU of the network entity 105-a may transmit a UE context modification request to a DU of the network entity 105-a, where the request may include the RRC reconfiguration 205. In some examples, the DU of the network entity 105-a may transmit a UE context modification response to the CU of the network entity 105-a

The network entity 105-a (e.g., the DU associated with the network entity 105-a) may forward the RRC reconfiguration 205 to the UE 115, which may trigger the UE 115 to perform a handover procedure to the network entity 105-b. In such cases, the RRC reconfiguration 205 may include an indication to perform a RACH-less handover procedure. Accordingly, as part of the RACH-less handover procedure, the UE 115 may refrain from communicating one or more RACH messages (e.g., MSG1 and MSG2) with the network entity 105-b. In response to the completion of the RACH-less procedure, the UE 115 may transmit an RRC reconfiguration 205 complete message to the network entity 105-b (e.g., the DU associated with the network entity 105-b), where the DU of the network entity 105-b may transmit an uplink RRC message transfer message to the CU of the network entity 105-b. Subsequently, the CU of the network entity 105-b may transmit, to the CU of the network entity 105-a, a UE context release message, where the CU and DU of the network entity 105-a may release the context associated with the UE 115.

In such cases, to enable the RACH-less handover procedure for direct-to-direct handovers, the RRC reconfiguration 205 may include a RACH-less handover information element (e.g., RACH-LessHO-R18), where the RACH-less handover information element may indicate a target TA value (e.g., targetNTA-r18) for use in the RACH-less handover, a beam indication information element (e.g., beamIndicationR-18), or both. The beam indication information element may indicate an identifier of a transmission configuration indicator (TCI) state (e.g., tci-StateID-r18) for use in the RACH-less handover and a synchronization signal block (SSB) index (e.g., ssb-Index-r18) associated with the RACH-less handover.

In such examples, the ssb-Index-r18 may indicate a beam that the UE 115 should use in the network entity 105-b (e.g., target cell) to monitor physical downlink control channel (PDCCH) for initial uplink transmission, where the network may configure the ssb-Index-r18 field in cases that the dynamic grant is used for initial uplink transmission in RACH-less handovers in non-terrestrial networks (NTNs). Further, the target TA value (e.g., targetNTA-r18) may refer to the timing adjustment indicating the TA value (e.g., N_{TA}) which the UE 115 uses for the target primary timing advance group (PTAG) of the handover. A value of zero may correspond to the target TA value being equal to 0 (e.g., N_{TA}=0), while a value of source may correspond to the target TA value (e.g., N_{TA}) of the network entity 105-a (e.g., the source serving cell. The value of source may be configured by the network in case the source cell is a mobile IAB cell. Further, the tci-StateID-r18 may indicate a beam that the UE 115 should use in the network entity 105-b (e.g., target cell) to monitor PDCCH for initial uplink transmission, where the network may configure the tci-StateID-r18 in cases that the target cell is a mobile IAB cell.

In such cases, the RRC reconfiguration 205 may be utilized to trigger switching to the network entity 105-b (e.g., target cell) for both direct-to-direct handovers and indirect-to-direct handovers. Accordingly, the RACH-less information element may be carried in the RRC reconfiguration 205 may enable the RACH-less switch towards the network entity 105-b for the indirect-to-direct handovers. As such, the network may configure (e.g., set) the beamIndication-r18 within the RACH-less information element for both direct-to-direct handovers (e.g., Uu to Uu switches) and indirect-to-direct (e.g., Sidelink to Uu switches) for a UE 115, for example, because the UE 115 may transmit a measurement report including information associated the network entity 105-b in both cases (e.g., based on which the switch is triggered).

In such cases, however, TA determination for RACH-less handovers for indirect-to-direct handovers may not be feasible. That is, the network may be unable to set the target TA value for direct-to-direct handovers, but may be unable to set the target TA value for indirect-to-direct handovers, for example, because setting the target TA value to zero may not be feasible in all deployments (e.g., based on the distance between the UE 115-b and the network entity 105-b), because setting the target TA value to source may be ill-defined due to the UE 115-b not having a source network entity (e.g., a source cell).

For example, because the UE 115-b communicates with the network entity 105-a via the UE 115-a, the UE 115-b may not have a TA value associated with the network entity 105-a, which may prohibit the TA value associated with the network entity 105-b from being set to the source TA value. Additionally, a TA value set to zero may not be feasible, for example, due to a distance between the network entity 105-band the UE 115-b. Thus, techniques may be desired to indicate a TA value to the remote UE 115 for use during RACH-less handover procedures.

The techniques, methods, and devices described herein enable the UE 115-bto receive a TA value associated with the network entity 105-b, which may enable the UE 115-b to perform the RACH-less handover procedure to the network entity 105-b. As such, the UE 115-b may experience a reduction in latency during handover procedures, due to the performance of the RACH-less handover.

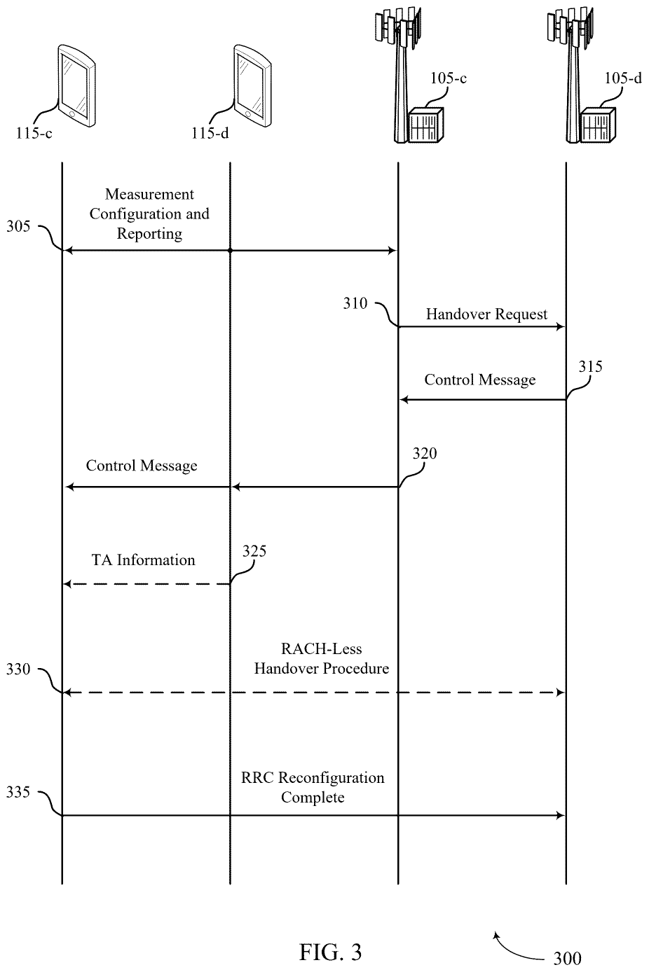

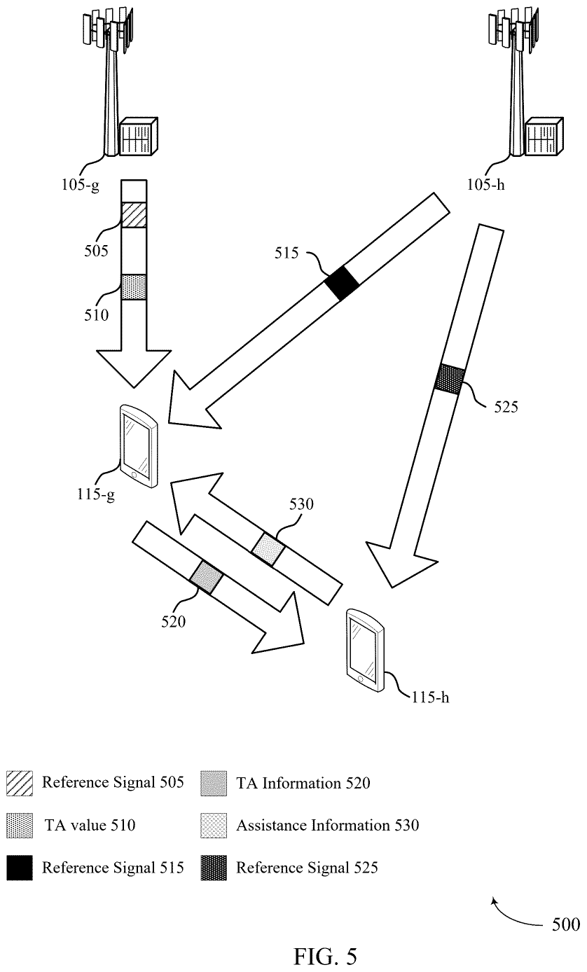

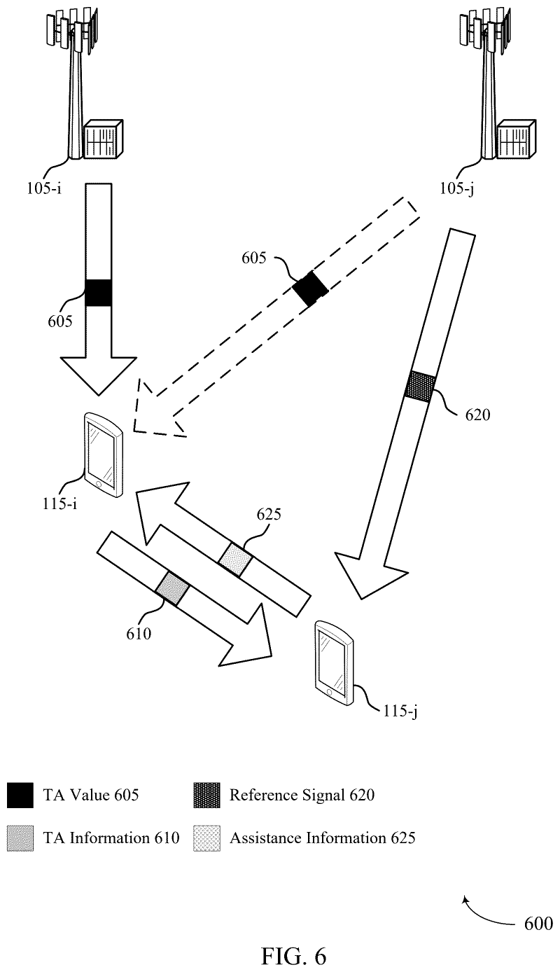

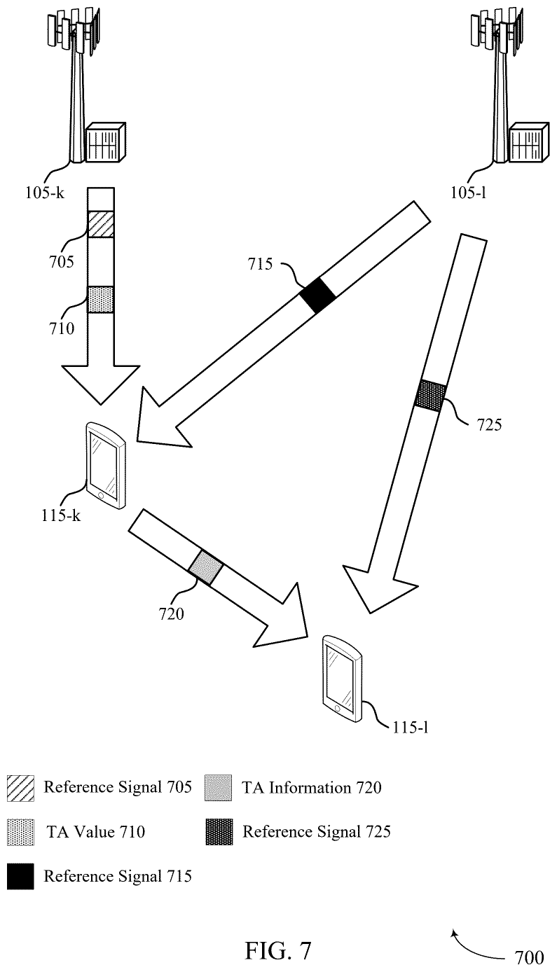

In some examples, the UE 115-a (e.g., relay UE) may provide an indication of a TA value related to the network entity 105-b (e.g., target cell) to the UE 115-b (e.g., remote UE). Such techniques may be further described herein with reference to FIG. 3. In one example, the UE 115-a may compute a TA value associated with the network entity 105-b and forward the computed TA value to the UE 115-b, where the UE 115-b may process and/or utilize the computed TA value. Such techniques may be further described herein with reference to FIG. 5. In another example, the UE 115-a may receive a TA value associated with communications between the UE 115-a and the network entity 105-b (in the case the UE 115-a connected to the network entity 105-b), where the UE 115-a may forward the received TA value to the UE 115-b. Such techniques may be further described herein with reference to FIG. 6. In another example, the UE 115-a may provide one or more parameters to the UE 115-b that enable the UE 115-b to compute a TA value associated with network entity 105-b. Such techniques may be further described herein with reference to FIG. 7.

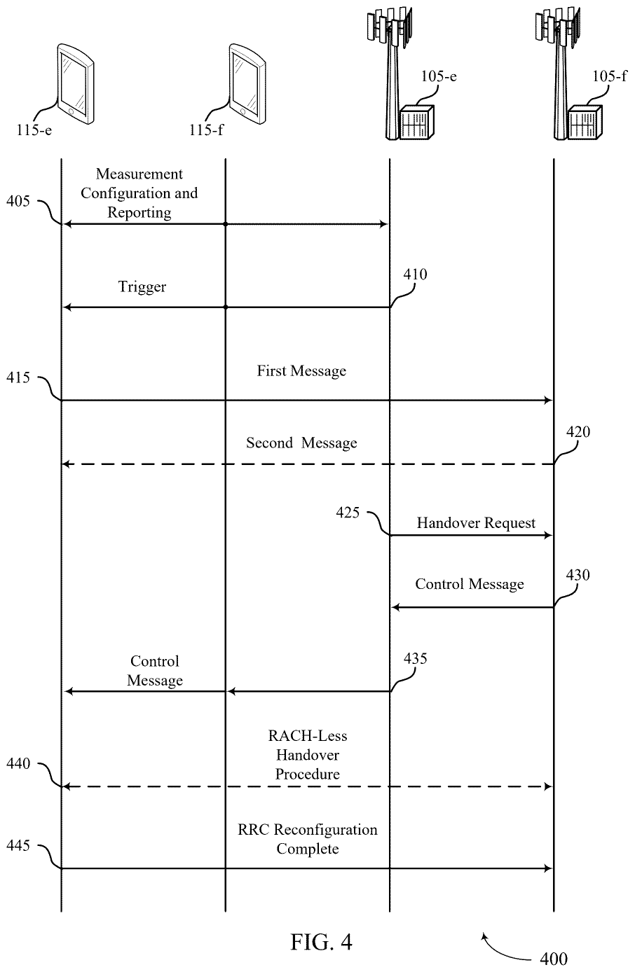

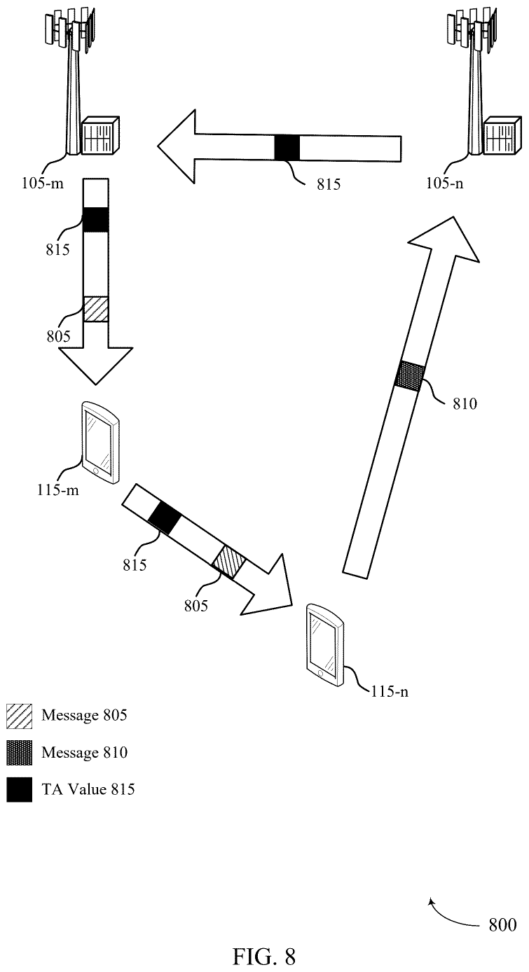

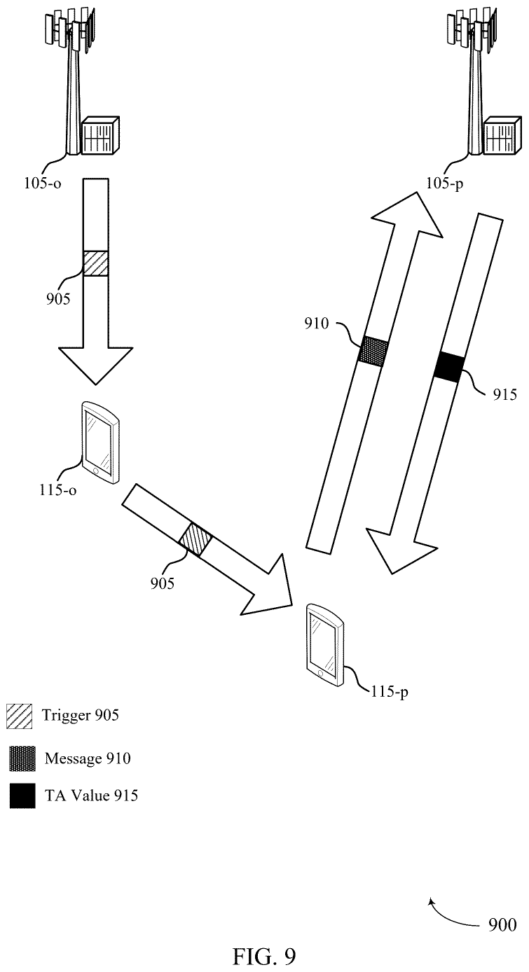

In some other examples, the UE 115-a may trigger (e.g., assist) the UE 115-b to perform an early RACH procedure with (e.g., towards) the network entity 105-b, where the network entity 105-b (or the network entity 105-a) may utilize the signals of the early RACH procedure to compute a TA value. Techniques to perform the early RACH procedure may be further described herein with reference to FIG. 4. In such examples, the UE 115-b may receive the computed TA value associated with the network entity 105-b from the network entity 105-a via the UE 115-a. Such techniques may be further described herein with reference to FIG. 8. In another example, the UE 115-b may receive the computed TA value associated with the network entity 105-b via a random-access response (RAR) (e.g., MSG 2) from the network entity 105-b. Such techniques may be further described herein with reference to FIG. 9. In some other examples, the network (e.g., the network entity 105-a, the network entity 105-b, or both) may determine the TA value for the UE 115-b according to a TA value associated with the UE 115-a (or some other metrics).

As described herein, the network entity 105-a and the network entity 105-b may be served by same DU, different DUs, be a same gNB, be different gNBs, or any combination thereof. Further, in some examples, the UE 115-b may also communicate a TA offset (e.g., communicated via SIB by remote or relay UE or via RRC by remote UE). In some examples, the UE 115-a may have the target cell of the UE 115-b as a serving cell. In such examples, the UE 115-a may already have the TA value associated with the target cell of the UE 115-b, where the UE 115-a may indicate the TA value to the UE 115-b.

FIG. 3 shows an example of a process flow 300 that supports timing synchronization during handover procedures in wireless communications in accordance with one or more aspects of the present disclosure. Aspects of the process flow 300 may implement, or be implemented to realize, aspects of the wireless communications system 100 and the wireless communications system 200. For example, the process flow 300 may include a UE 115-c (e.g., a remote UE), a UE 115-d (e.g., relay UE), a network entity 105-c (e.g., source cell), and a network entity 105-d (e.g., target cell), which may be examples of corresponding devices as described herein.

In the following description of the process flow 300, the operations between the devices may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time. The techniques described in the context of the process flow 300 may enable the UE 115-d to provide the UE 115-c with TA information associated with the network entity 105-d, such that the UE 115-c may perform a RACH-Less handover procedure for indirect-to-direct handovers.

At 305, the network entity 105-c may provide the UE 115-c with a measurement configuration (e.g., via RRC signaling, a system information block (SIB), among other examples) to measure one or more target network entities, including the network entity 105-d. In such examples, the network entity 105-c may indicate the measurement configuration to the UE 115-c via the UE 115-d. In response to receiving the measurement configuration, the UE 115-c may measure the indicated network entities and provide a measurement report to the network entity 105-c via the UE 115-d.

At 310, the network entity 105-c may determine that the UE 115-c is to perform a handover procedure to the network entity 105-d according to the measurement report. In such examples, the network entity 105-c may transmit a handover request to the network entity 105-d, where the handover request may indicate for the UE 115-c to perform the handover procedure to the network entity 105-d. In such examples, the handover request may include an indication that the UE 115-c is a remote UE (e.g., connected to the network entity 105-c via the UE 115-d), include an indication (e.g., the identifier) of the UE 115-d, include a request for the UE 115-c to perform a RACH-less handover procedure, or any combination thereof. In some examples, the network entity 105-c may transmit assistance information to the network entity 105-d in addition to the handover request, where the assistance information may indicate that the UE 115-c is a remote UE, indicate the identifier of the UE 115-d, include a request for the UE 115-c to perform a RACH-less handover procedure, or any combination thereof.

At 315, the network entity 105-d may determine (e.g., admit) that the UE 115-c is to perform a RACH-less handover procedure. In such examples, the network entity 105-d may make such a determination based on the assistance information, the handover request, or both. In response to determining that the UE 115-c is to perform the RACH-less handover, the network entity 105-d may generate a handover configuration (e.g., RRC reconfiguration 205) that includes the RACH-less indication (e.g., the RACH-LessHO-R18 information element). In some examples, the handover configuration (via the RACH-LessHO-R18 information element) may include an indication (e.g., identifier) of the UE 115-d, where the assistance of the UE 115-d may enable the UE 115-c to acquire (e.g., obtain or otherwise receive) a TA value associated with the network entity 105-d and perform the RACH-less handover procedure.

In response to generating the handover configuration (e.g., RRC reconfiguration 205), the network entity 105-d may transmit a control message (e.g., a handover request acknowledgement) that includes the handover configuration (e.g., RRC reconfiguration message) to the network entity 105-c. That is, the network entity 105-d may transmit a control message that indicates for the UE 115-c to perform the RACH-less handover procedure. At 320, the network entity 105-c may forward the received control message (e.g., handover configuration, RRC reconfiguration) to the relay UE 115-c via the relay UE 115-d.

At 325, the UE 115-c may obtain TA information form the UE 115-d. In some examples, the UE 115-d may compute a TA value associated with communications between the UE 115-d and the target cell and indicate the computed TA value to the UE 115-c, where the UE 115-c may adjust and/or utilize the computed TA value for the RACH-less handover procedure. Such techniques may be further described herein with reference to FIG. 5. In some examples, the UE 115-d may receive the TA value from one or both of the network entities 105-c and 105-d and indicate the TA value to the UE 115-c. Such techniques may be further described herein with reference to FIG. 6. In some examples, the UE 115-d may indicate one or more parameters to the UE 115-c, where the UE 115-c may calculate the TA value associated with communications between the UE 115-c and the network entity 105-d based on the one or more parameters. Such techniques may be further described herein with reference to FIG. 7.

At 330, the UE 115-c may perform the RACH-less handover procedure to connect to the network entity 105-d using the TA value received at 325. For example, as part of the RACH-less handover, the UE 115-c may refrain from communicating MSG 1 and/or MSG2 of a RACH procedure. At 335, in response to completing the RACH-less handover, the UE 115-c may transmit an RRC reconfiguration complete message to the network entity 105-d.

FIG. 4 shows an example of a process flow 400 that supports timing synchronization during handover procedures in wireless communications in accordance with one or more aspects of the present disclosure. Aspects of the process flow 400 may implement, or be implemented to realize, aspects of the wireless communications system 100, the wireless communications system 200, and the process flow 300. For example, the process flow 400 may include a UE 115-e (e.g., a remote UE), a UE 115-f (e.g., relay UE), a network entity 105-e (e.g., source cell), and a network entity 105-f (e.g., target cell), which may be examples of corresponding devices as described herein.

In the following description of the process flow 400, the operations between the devices may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time. The techniques described in the context of the process flow 400 may enable the UE 115-e to obtain TA information associated with the network entity 105-f, such that the UE 115-e may perform a RACH-Less handover procedure for indirect-to-direct handovers.

At 405, the network entity 105-e may provide the UE 115-e with a measurement configuration (e.g., via RRC signaling, a system information block (SIB), among other examples) to measure one or more target network entities, including the network entity 105-f. In such examples, the network entity 105-e may indicate the measurement configuration to the UE 115-e via the UE 115-f. In response to receiving the measurement configuration, the UE 115-e may measure the indicated network entities and provide a measurement report to the network entity 105-e via the UE 115-f.

At 410, the network entity 105-e may determine that the UE 115-e is to perform a handover procedure to the network entity 105-f according to the measurement report. In such examples, the network entity 105-f may transmit signaling (e.g., RRC signaling, downlink control information (DCI), a MAC control element (MAC-CE), SIB, among other examples) to trigger the UE 115-e to perform an early RACH procedure. As illustrated, the network entity 105-e may transmit the signaling to the UE 115-f, where the UE 115-f may forward the signaling to the UE 115-e. Techniques to trigger the UE 115-e to perform the early RACH procedure may be further described herein with reference to FIG. 8.

At 415, in response to receiving the trigger, the UE 115-e may perform a procedure to obtain a TA value for communications between the UE 115-e and the network entity 105-f, such as the early RACH procedure. For example, the UE 115-e may transmit a first message (e.g., MSG1, a first RACH message, a first reference signal, a first early indication, a first request signal) to the network entity 105-f. Accordingly, the network entity 105-f may compute a TA value associated with the network entity 105-f. In some examples, at 420, the network entity 105-f may indicate the computed TA value to the UE 115-e via a second message (e.g., MSG 2, a second RACH message, a second reference signal, a TA indication, RAR, a response signal), which may be further described herein with reference to FIG. 9.

At 425, in response to completion of the procedure, the network entity 105-e may transmit a handover request to the network entity 105-f, where the handover request may indicate for the UE 115-e to perform the handover procedure to the network entity 105-f. In such examples, the handover request may include an indication that the UE 115-e is a remote UE (e.g., connected to the network entity 105-e via the UE 115-f), include an indication (e.g., the identifier) of the UE 115-f, include a request for the UE 115-e to perform a RACH-less handover procedure, or any combination thereof. In some examples, the network entity 105-e may transmit assistance information to the network entity 105-f in addition to the handover request, where the assistance information may indicate that the UE 115-e is a remote UE, indicate the identifier of the UE 115-f, include a request for the UE 115-e to perform a RACH-less handover procedure, or any combination thereof.

At 430, the network entity 105-f may determine (e.g., admit) that the UE 115-e is to perform a RACH-less handover procedure. In such examples, the network entity 105-f may make such a determination based on the assistance information, the handover request, the completion of the early RACH procedure, or any combination thereof. In response to determining that the UE 115-e is to perform the RACH-less handover, the network entity 105-f may generate a handover configuration (e.g., RRC reconfiguration 205) that includes the RACH-less indication (e.g., the RACH-LessHO-R18 information element). In some examples, the handover configuration (via the RACH-LessHO-R18 information element) may include an indication (e.g., identifier) of the UE 115-f, where the assistance of the UE 115-f may enable the UE 115-e to acquire (e.g., obtain or otherwise receive) the computed TA value associated with the network entity 105-f and perform the RACH-less handover procedure. Further, in some examples, the network entity 105-f may include, in the RACH-LessHO-R18 information element of the handover configuration (e.g., RRC reconfiguration 205) the TA value computed at 415.

In response to generating the handover configuration (e.g., RRC reconfiguration 205), the network entity 105-f may transmit a control message (e.g., a handover request acknowledgement message) that includes the handover configuration to the network entity 105-e. That is, the network entity 105-f may transmit a control message that indicates for the UE 115-e to perform the RACH-less handover procedure and indicates the computed TA value. Techniques to indicate the computed TA value via the handover configuration (e.g., RRC reconfiguration) may be further described herein with reference to FIG. 8. At 435, the network entity 105-e may forward the received control message (e.g., handover configuration, RRC reconfiguration) to the relay UE 115-e via the UE 115-f.

At 440, the UE 115-e may perform the RACH-less handover procedure to connect to the network entity 105-f using the TA value received at 420 or at 435. For example, as part of the RACH-less handover, the UE 115-e may refrain from communicating MSG1 and/or MSG2 of a RACH procedure. At 445, in response to completing the RACH-less handover, the UE 115-e may transmit an RRC reconfiguration complete message to the network entity 105-f.

FIG. 5 shows an example of a wireless communications system 500 that supports timing synchronization during handover procedures in wireless communications in accordance with one or more aspects of the present disclosure. Aspects of the wireless communications system 500 may implement, or be implemented to realize, aspects of the wireless communications system 100, the wireless communications system 200, the process flow 300, and the process flow 400. For example, the wireless communications system 500 may include a network entity 105-g (e.g., a source cell), a network entity 105-h (e.g., a target cell), a UE 115-g (e.g., a relay UE), and a UE 115-h (e.g., a remote UE), which may be examples of corresponding devices as described herein.

The techniques described in the context of the wireless communications system 500 may enable the UE 115-g to compute a TA value associated with the network entity 105-h and indicate the computed TA value to the UE 115-h, such that the UE 115-h may utilize the computed TA value for a RACH-less handover procedure to the network entity 105-h. Further, the techniques described in the context of the wireless communications system 500 may correspond to the operations at 325 of FIG. 3.

For example, the UE 115-g may compute a first TA value, where the first TA value is associated with communications between the UE 115-g and the network entity 105-h. In such examples, the UE 115-g may compute the first TA value based on measuring a time difference between the reception of a reference signal 505 from the network entity 105-g and reception of a reference signal 515 from the network entity 105-h and combining (e.g., adding) the difference with a TA value 510 that the UE 115-g receives for communication with the network entity 105-g.

In some implementations, in response to computing the first TA value, the UE 115-g may transmit TA information 520 to the UE 115-h, where the TA information 520 may include the first TA value. In some examples, the UE 115-h may apply the first TA value as is for performance of the RACH-less handover procedure. In some other examples, the UE 115-h may adjust the first TA value according to a reception time of a reference signal 525 from the network entity 105-h to obtain a second TA value, where the second TA value may be associated with communications between the UE 115-h and the network entity 105-h. Accordingly, the UE 115-h may utilize the second TA value for performance of the RACH-less handover procedure with the network entity 105-h. Additionally, or alternatively, the UE 115-h may adjust the first TA value according to a timing adjustment (e.g., a TA value) utilized by the UE 115-h in communications with the UE 115-g, according to location information of the UE 115-g (received via the TA information 520 or separate assistance information 530), or both, to obtain the second TA value. Accordingly, the UE 115-h may utilize the second TA value for performance of the RACH-less handover procedure with the network entity 105-h.

In some other implementations, in response to computing the first TA value, the UE 115-g may adjust the first TA value according to location information associated with the UE 115-h, measurement information associated with UE 115-h, or both to obtain the second TA value. For example, the UE 115-g and the UE 115-h may exchange assistance information 530 that includes the location information, the measurement information, or both. Accordingly, the UE 115-g may utilize such information to adjust the first TA value and obtain the second TA value, such that the second TA value may be associated with communications between the UE 115-h and the network entity 105-h. In response, the UE 115-g may indicate the second TA value to the UE 115-h via the TA information 520, where the UE 115-h may utilize the second TA value for the RACH-less handover procedure.

In some examples, the UE 115-g may receive an indication to adjust the first TA value (e.g., to obtain the second TA value). For example, the UE 115-g may receive an indication from the network entity 105-g (or the network entity 105-h) to adjust the first TA value and obtain the second TA value. In another example, the UE 115-g may receive a request from the UE 115-h to adjust the first TA value and obtain the second TA value.

In addition to indicating the first TA value or the second TA value (e.g., adjusted first TA value), the UE 115-g and the UE 115-h may exchange information related to the validity of the first TA value or the second TA value (e.g., computed TA value). That is, the UE 115-g may indicate, via the TA information 520 and in addition to the first TA value or the second TA value, a timing at which the first TA value or the second TA value has been computed. The UE 115-h may utilize such validity information (e.g., time of computation) in combination with an RRC configuration of a time alignment timer (TAT) to determine a remaining validity time of the first TA value or the second TA value.

FIG. 6 shows an example of a wireless communications system 600 that supports timing synchronization during handover procedures in wireless communications in accordance with one or more aspects of the present disclosure. Aspects of the wireless communications system 600 may implement, or be implemented to realize, aspects of the wireless communications system 100, the wireless communications system 200, the process flow 300, the process flow 400, and the wireless communications system 500. The wireless communications system 600 may be implemented by a network entity 105-i (e.g., a source cell), a network entity 105-j (e.g., a target cell), a UE 115-i (e.g., relay UE), and a UE 115-j (e.g., a remote UE), which may be examples of corresponding devices as described herein.

The techniques described in the context of the wireless communications system 600 may enable the relay UE 115-i to receive a TA value 605 associated with communications between the UE 115-i and the network entity 105-j and indicate the TA value 605 to the UE 115-j, such that the UE 115-j may utilize the TA value 605 for a RACH-less handover procedure. Further, the techniques described in the context of the wireless communications system 600 may correspond to the operations at 325 of FIG. 3.

For example, the UE 115-i may receive, from the network entity 105-i, the network entity 105-j, or both, the TA value 605 (e.g., first TA value), where the TA value 605 may be associated with communications between the network entity 105-j and the UE 115-i (e.g., TA of target cell for relay UE). That is, the UE 115-i may receive from the network the TA value 605 that the UE 115-i would utilize in the case the UE 115-i connected to the network entity 105-j.

In such examples, the network entity 105-j (or the network entity 105-i) may compute the TA value 605, where the computation may be based on a procedure performed by the UE 115-i towards the network entity 105-j, such as an early RACH procedure. For example, as part of the procedure, the UE 115-i may transmit a first message (e.g., MSG1, a first RACH message, a first reference signal, an early indication, a request signal) to the network entity 105-j, where the network entity 105-j may utilize the reception of the first message to compute the TA value 605. Accordingly, the network entity 105-j may indicate the computed TA value 605 to the UE 115-i via a second message (e.g., MSG 2, a second RACH message, a second reference signal, a TA indication, a response signal, or RAR) or indicate the computed TA value 605 to the UE 115-i via the network entity 105-i (e.g., via the handover configuration or other signaling). As described herein, the procedure may be performed by the UE 115-i prior to communication of the handover request from the network entity 105-i to the network entity 105-j. In such examples, the UE 115-i may perform the procedure in response to a trigger from the network entity 105-i.

In some examples, the network entity 105-j may proactively adjust the TA value 605 to obtain a second TA value based on assistance information 625 related to UE 115-j. For example, the UE 115-i may receive assistance information 625 from the UE 115-j, where the assistance information 625 may include location information associated with the UE 115-j, measurement information associated with the UE 115-j, or both. Accordingly, the UE 115-i may forward the assistance information 625 to the network entity 105-j (e.g., directly or via the network entity 105-i), such that the network entity 105-j may utilize the assistance information 625 to adjust the computed TA value 605 and obtain a second TA value associated with communications between the UE 115-j and the network entity 105-j. As such, the network entity 105-j may indicate the second TA value (not shown) to the UE 115-i or indicate the second TA value to the network entity 105-i, where the network entity 105-i may forward the second TA value to the UE 115-i.

In response to receiving the TA value 605 or the second TA value, the UE 115-i may transmit TA information 610, where the TA information 610 may include the TA value 605 or the second TA value. The UE 115-j may proceed to utilize the TA value 605 or the second TA value for the RACH-less handover procedure.

In some examples, if the UE 115-i receives the TA value 605 (e.g., the unadjusted TA value), the UE 115-i may proactively adjust the TA value 605 to obtain the second TA value in accordance with the techniques described herein with reference to FIG. 5. As such, the UE 115-i may indicate the second TA value to the UE 115-j via the TA information 610.

In some examples, if the UE 115-j receives the TA value 605 (e.g., unadjusted TA value, the TA information 610 may also include location information associated with the UE 115-i, such that the UE 115-j may adjust the TA value 605 to obtain the second TA value in accordance with the techniques described herein with reference to FIG. 5. Further, the UE 115-j may receive a reference signal 620, such that the UE 115-j may adjust the TA value 605 according to a reception time of the reference signal 620.

FIG. 7 shows an example of a wireless communications system 700 that supports timing synchronization during handover procedures in wireless communications in accordance with one or more aspects of the present disclosure. Aspects of the wireless communications system 700 may implement, or be implemented to realize, aspects of the wireless communications system 100, the wireless communications system 200, the process flow 300, the process flow 400, wireless communications system 500, and the wireless communications system 600. For example, the wireless communications system 700 may include a network entity 105-k (e.g., source cell), a network entity 105-l (e.g., a target cell), a UE 115-k (e.g., a relay UE), and a UE 115-l (e.g., a remote UE), which may be examples of corresponding devices as described herein.

The techniques described in the context of the wireless communications system 700 may enable the UE 115-l to compute a TA value associated with communications between the UE 115-l and the network entity 105-l according to information received from the UE 115-k. Further, the techniques described in the context of the wireless communications system 700 may correspond to the operations at 325 of FIG. 3.

For example, the UE 115-k may receive a reference signal 705 from the network entity 105-k, receive a TA value 710 associated with communications between the network entity 105-k and the UE 115-k, and receive a reference signal 715 from the network entity 105-l. Accordingly, the UE 115-k may transmit TA information 720 (e.g., assistance information) to the UE 115-l, where the TA information 720 may include information that is utilized by the UE 115-l to compute the TA value for communications between the UE 115-l and the network entity 105-l.

For example, the TA information 720 may include a reception time of the reference signal 705 at the UE 115-k, a reception time of the reference signal 715 at the UE 115-k, the TA value 710, location information associated with the UE 115-k, measurement information associated with the UE 115-k, or any combination thereof. Accordingly, the UE 115-l may utilize the TA information 720 to compute the TA value for the RACH-less handover procedure. In some examples, in addition to the TA information 720, the UE 115-l may utilize a reception timing of a reference signal 725 received from the network entity 105-l to compute (e.g., or adjust) the TA value between network entity 105-l and the UE 115-l.

FIG. 8 shows an example of a wireless communications system 800 that supports timing synchronization during handover procedures in wireless communications in accordance with one or more aspects of the present disclosure. Aspects of the wireless communications system 800 may implement, or be implemented to realize, aspects of the wireless communications system 100, the wireless communications system 200, the process flow 300, the process flow 400, wireless communications system 500, the wireless communications system 600, and the wireless communications system 700. For example, the wireless communications system 800 may include a network entity 105-m (e.g., a source cell), a network entity 105-n (e.g., a target cell), a UE 115-m (e.g., a relay UE), and a UE 115-n (e.g., a remote UE), which may be examples of corresponding devices as described herein.

The techniques described in the context of the wireless communications system 800 may enable the UE 115-n to perform a procedure (e.g., an early RACH procedure) towards the network entity 105-n, such that the network entity 105-n may compute a TA value 815 for the RACH-less handover procedure. The techniques described in the context of the wireless communications system 800 may correspond to the operations at 415 of FIG. 4.

In some examples, the UE 115-n may be triggered to transmit a message 810 (e.g., a first RACH message, MSG1, RACH preamble, a first reference signal, an early indication, a TA request signal, among other examples) prior to handover triggering and outside interruption time to the network entity 105-n, such that the network entity 105-n may compute the TA value 815 for communications between the UE 115-n and the network entity 105-n. That is, the UE 115-n may be triggered to perform the procedure (e.g., early RACH procedure), which may include communication of the message 810 prior to the communication of the handover request from the network entity 105-m to the network entity 105-n for the UE 115-n.

In such examples, the network entity 105-m may transmit a message 805 (e.g., a control message) to the UE 115-n via the UE 115-m over the top, where the message may trigger the UE 115-n to perform the early RACH procedure. In some other examples, the network entity 105-m may indicate (e.g., ask), via the message 805, for the UE 115-m to order the UE 115-n to perform the early RACH procedure. Accordingly, the UE 115-n may transmit the message 805 that orders the UE 115-n to perform the procedure (e.g., send the message 810). In some examples, the network entity 105-m may transmit a direct message 805 to the UE 115-n to trigger the UE 115-n to perform the procedure (e.g., the early RACH procedure), where the direct message 805 is carried transparently to the UE 115-n via the UE 115-m. In such examples, the messages 805 may be RRC messages, MAC-CEs, DCI messages, sidelink control information (SCI) messages, or any combination thereof.

To facilitate the procedure, the UE 115-n may receive an indication of a resource (e.g., a RACH resource, a preamble ID, RACH occasion indication, time and frequency resources, among other examples) for communication of the message 810 from the network entity 105-m or from the UE 115-m. Accordingly, the UE 115-n may transmit the message 810 via the resource and according to the triggers.

In response to receiving the message 810, the network entity 105-p may compute the TA value 815 using the message 810 and may forward the TA value 815 to the network entity 105-o (e.g., serving cell of the relay UE), where the network entity 105-o may forward the TA value 815 to the UE 115-p via the UE 115-o.

In some examples, the network entity 105-p may indicate the computed TA value 815 to the network entity 105-o via the handover command (e.g., the control message at 430, the handover configuration, the RRC reconfiguration), where the network entity 105-g may indicate the computed TA value 815 to the UE 115-o via the handover command (e.g., the control message at 435, the handover configuration, the RRC reconfiguration), and where the UE 115-o may indicate the computed TA value 815 to the UE 115-p via the handover command (e.g., the control message at 435, the handover configuration, the RRC reconfiguration).

In some other examples, the network entity 105-p may indicate the TA value 815 to the network entity 105-o via a signal communicated separately from the handover command. Similarly, the network entity 105-o may indicate the TA value 815 to the UE 115-o in a signal communicated separately from the handover command, such that the UE 115-o may indicate the TA value 815 in a signal communicated separately from the handover command.

In addition to indicating the TA value 815, the network entity 105-p may also indicate an identifier of the network entity 105-p, an indication of the resource (e.g., the RACH resource), or both to the network entity 105-o, where the network entity 105-o may utilize such information to identify the UE 115-o and indicate such information to the UE 115-o.

FIG. 9 shows an example of a wireless communications system 900 that supports timing synchronization during handover procedures in wireless communications in accordance with one or more aspects of the present disclosure. Aspects of the wireless communications system 900 may implement, or be implemented to realize, aspects of the wireless communications system 100, the wireless communications system 200, the process flow 300, the process flow 400, wireless communications system 500, the wireless communications system 600, the wireless communications system 700, and the wireless communications system 800. For example, the wireless communications system 900 may include a network entity 105-o (e.g., a source cell), a network entity 105-p (e.g., a target cell), a UE 115-o (e.g., a relay UE), and a UE 115-p (e.g., a remote UE), which may be examples of corresponding devices as described herein.

The techniques described in the context of the wireless communications system 900 may enable the UE 115-p to perform a procedure (e.g., an early RACH procedure) towards the network entity 105-p, such that the network entity 105-p may compute a TA value 915 for the RACH-less handover procedure. The techniques described in the context of the wireless communications system 900 may correspond to the operations at 415 and 420 of FIG. 4.

In some examples, the UE 115-p may be triggered to transmit a message 910 (e.g., a first RACH message, MSG1, RACH preamble, a first reference signal, an early indication, a TA request signal, among other examples) prior to handover triggering and outside interruption time to the network entity 105-p, such that the network entity 105-p may compute the TA value 915 for communications between the UE 115-p and the network entity 105-p. That is, the UE 115-p may be triggered to perform the procedure, which may include communication of the message 910 prior to the communication of the handover request from the network entity 105-o to the network entity 105-p for the UE 115-p.

In such examples, the network entity 105-o may transmit a message 905 (e.g., a control message) to the UE 115-p via the UE 115-o over the top, where the message may trigger the UE 115-p to perform the procedure (e.g., early RACH procedure, TA obtainment procedure). In some other examples, the network entity 105-o may indicate (e.g., ask), via the message 905, for the UE 115-o to order the UE 115-p to perform the procedure. Accordingly, the UE 115-p may transmit the message 905 that orders the UE 115-p to perform the procedure (e.g., send the message 910). In some examples, the network entity 105-o may transmit a direct message 905 to the UE 115-p to trigger the UE 115-p to perform the procedure, where the direct message 905 is carried transparently to the UE 115-p via the UE 115-o. In such examples, the messages 905 may be RRC messages, MAC-CEs, DCI messages, SCI messages, or any combination thereof.

To facilitate the procedure, the UE 115-p may receive an indication of a resource (e.g., a RACH resource, a preamble ID, RACH occasion indication, time and frequency resources, among other examples) for communication of the message 910 from the network entity 105-o or from the UE 115-o. Accordingly, the UE 115-p may transmit the message 910 via the RACH resource and according to the triggers. In response to receiving the message 910, the network entity 105-p may compute the TA value 915 using the message 910 and may transmit the TA value 915 to the UE 115-p via a second message (e.g., MSG2, a second RACH message, a second reference signal, a TA indication, a response signal, or RAR).

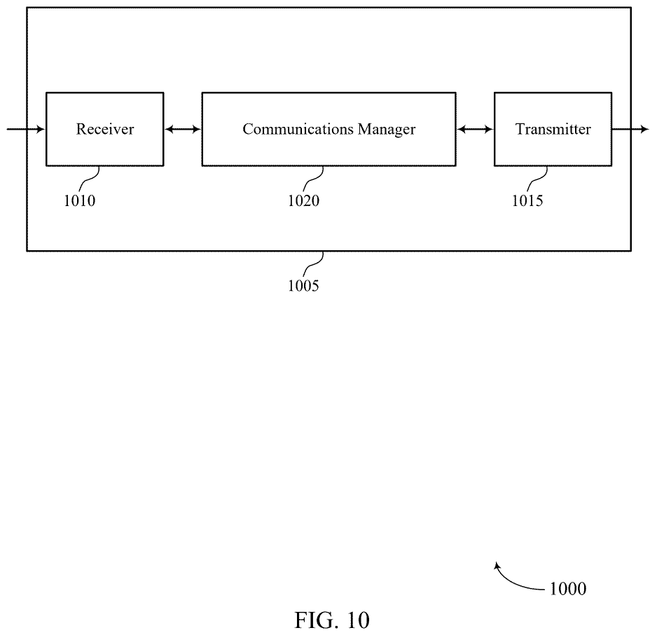

FIG. 10 shows a block diagram 1000 of a device 1005 that supports timing synchronization during handover procedures in wireless communications in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to timing synchronization during handover procedures in wireless communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to timing synchronization during handover procedures in wireless communications). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations or components thereof may be examples of means for performing various aspects of timing synchronization during handover procedures in wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for forwarding, from a first network entity to a remote UE in communication with the relay UE, a control message indicating that the remote UE is to perform a procedure with a second network entity. The communications manager 1020 is capable of, configured to, or operable to support a means for obtaining, in accordance with forwarding the control message to the remote UE, TA information used for communications between the second network entity and the remote UE. The communications manager 1020 is capable of, configured to, or operable to support a means for transmitting the TA information to the remote UE in accordance with obtaining the TA information.

Additionally, or alternatively, the communications manager 1020 may support wireless communications in accordance with examples as disclosed herein. For example, the communications manager 1020 is capable of, configured to, or operable to support a means for receiving, from a first network entity via a relay UE, a control message indicating that the remote UE is to perform a procedure with a second network entity. The communications manager 1020 is capable of, configured to, or operable to support a means for obtaining, in accordance with receiving the control message, TA information used for communications between the second network entity and the remote UE. The communications manager 1020 is capable of, configured to, or operable to support a means for communicating with the second network entity according to the TA information.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

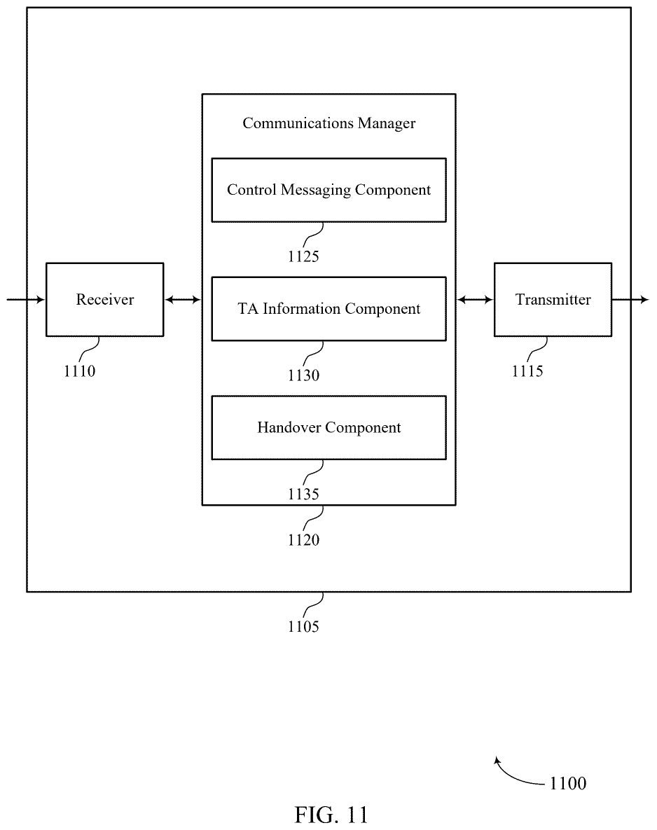

FIG. 11 shows a block diagram 1100 of a device 1105 that supports timing synchronization during handover procedures in wireless communications in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to timing synchronization during handover procedures in wireless communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to timing synchronization during handover procedures in wireless communications). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of timing synchronization during handover procedures in wireless communications as described herein. For example, the communications manager 1120 may include a control messaging component 1125, a TA information component 1130, a handover component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The control messaging component 1125 is capable of, configured to, or operable to support a means for forwarding, from a first network entity to a remote UE in communication with the relay UE, a control message indicating that the remote UE is to perform a procedure with a second network entity. The TA information component 1130 is capable of, configured to, or operable to support a means for obtaining, in accordance with forwarding the control message to the remote UE, TA information used for communications between the second network entity and the remote UE. The TA information component 1130 is capable of, configured to, or operable to support a means for transmitting the TA information to the remote UE in accordance with obtaining the TA information.

Additionally, or alternatively, the communications manager 1120 may support wireless communications in accordance with examples as disclosed herein. The control messaging component 1125 is capable of, configured to, or operable to support a means for receiving, from a first network entity via a relay UE, a control message indicating that the remote UE is to perform a procedure with a second network entity. The TA information component 1130 is capable of, configured to, or operable to support a means for obtaining, in accordance with receiving the control message, TA information used for communications between the second network entity and the remote UE. The handover component 1135 is capable of, configured to, or operable to support a means for communicating with the second network entity according to the TA information.

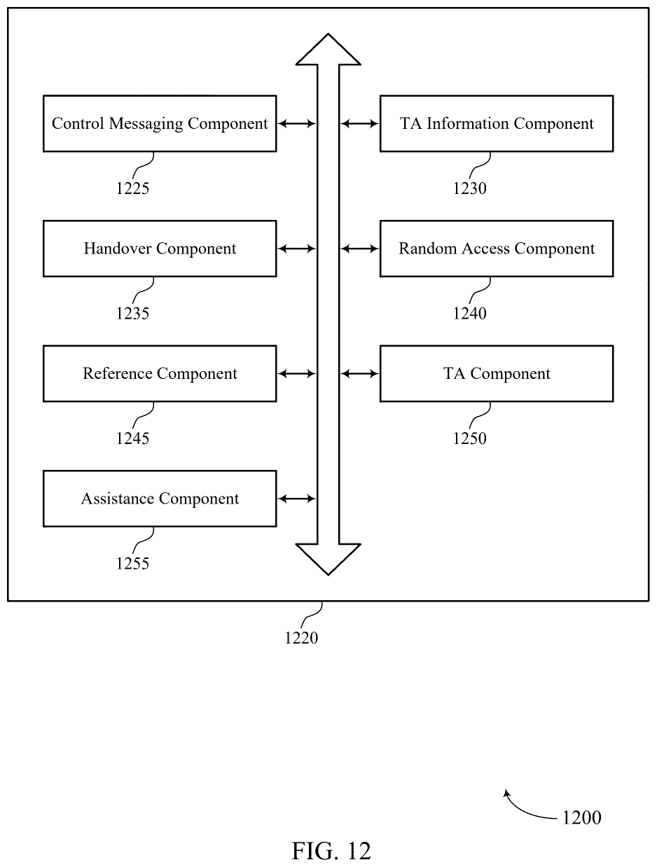

FIG. 12 shows a block diagram 1200 of a communications manager 1220 that supports timing synchronization during handover procedures in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of timing synchronization during handover procedures in wireless communications as described herein. For example, the communications manager 1220 may include a control messaging component 1225, a TA information component 1230, a handover component 1235, a random-access component 1240, a reference component 1245, a TA component 1250, an assistance component 1255, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The control messaging component 1225 is capable of, configured to, or operable to support a means for forwarding, from a first network entity to a remote UE in communication with the relay UE, a control message indicating that the remote UE is to perform a procedure with a second network entity. The TA information component 1230 is capable of, configured to, or operable to support a means for obtaining, in accordance with forwarding the control message to the remote UE, TA information used for communications between the second network entity and the remote UE. In some examples, the TA information component 1230 is capable of, configured to, or operable to support a means for transmitting the TA information to the remote UE in accordance with obtaining the TA information.

In some examples, the procedure is a handover procedure. In some examples, the control message further indicates that the remote UE is to perform the handover procedure to the second network entity without communicating a first random-access message and a second random-access message of a RACH procedure.

In some examples, to support obtaining the TA information, the TA information component 1230 is capable of, configured to, or operable to support a means for computing a first TA value associated with communications between the relay UE and the second network entity, where the TA information includes an indication of the first TA value, location information associated with the relay UE, or both.

In some examples, the reference component 1245 is capable of, configured to, or operable to support a means for receiving one or more first reference signals from the first network entity. In some examples, the reference component 1245 is capable of, configured to, or operable to support a means for receiving one or more second reference signals from the second network entity, where computing the first TA value is in accordance with the one or more first reference signals, the one or more second reference signals, a second TA value associated with communications between the relay UE and the first network entity, or any combination thereof.

In some examples, the TA component 1250 is capable of, configured to, or operable to support a means for obtaining a second TA value associated with communications between the remote UE and the second network entity in accordance with an adjustment of the first TA value using the location information of the remote UE, measurement information of the remote UE, or both, where the TA information includes the second TA value.

In some examples, the assistance component 1255 is capable of, configured to, or operable to support a means for receiving assistance information from the remote UE, where the assistance information includes the location information of the remote UE, the measurement information of the remote UE, or both.

In some examples, the TA information component 1230 is capable of, configured to, or operable to support a means for obtaining a first TA value used for communications between the relay UE and the second network entity, where the TA information includes the first TA value.

In some examples, the first TA value is obtained from the first network entity, obtained from the second network entity, obtained in accordance with communication of a first message from the relay UE to the second network entity, or any combination thereof.

In some examples, the TA information includes a first reception time at the relay UE of a first reference signal from the first network entity, a second reception time at the relay UE of a second reference signal from the second network entity, a first TA value used for communications between the relay UE and the first network entity, location information of the relay UE, or any combination thereof.

In some examples, to support forwarding the control message, the random-access component 1240 is capable of, configured to, or operable to support a means for receiving, from the first network entity, a trigger for the remote UE to perform the early random-access procedure with the second network entity. In some examples, to support forwarding the control message, the random-access component 1240 is capable of, configured to, or operable to support a means for transmitting, to the remote UE, the trigger for the remote UE to perform the early random-access procedure with the second network entity, where obtaining the TA information is in accordance with transmitting the trigger for the remote UE to perform the early random-access procedure.

In some examples, to support obtaining the TA information, the TA information component 1230 is capable of, configured to, or operable to support a means for receiving, from the first network entity, an indication of the TA information, where transmitting the TA information is in accordance with receiving the indication.

Additionally, or alternatively, the communications manager 1220 may support wireless communications in accordance with examples as disclosed herein. In some examples, the control messaging component 1225 is capable of, configured to, or operable to support a means for receiving, from a first network entity via a relay UE, a control message indicating that the remote UE is to perform a procedure with a second network entity. In some examples, the TA information component 1230 is capable of, configured to, or operable to support a means for obtaining, in accordance with receiving the control message, TA information used for communications between the second network entity and the remote UE. The handover component 1235 is capable of, configured to, or operable to support a means for communicating with the second network entity according to the TA information.

In some examples, the procedure is a handover procedure. In some examples, the control message further indicates that the remote UE is to perform the handover procedure to the second network entity without communicating a first random-access message and a second random-access message of a RACH procedure.

In some examples, the TA information includes a first reception time at the relay UE of a first reference signal from the first network entity, and the TA information component 1230 is capable of, configured to, or operable to support a means for computing a TA value used for communications between the remote UE and the second network entity using the TA information.

In some examples, the TA information includes a first TA used for communications between the relay UE and the second network entity, and the TA information component 1230 is capable of, configured to, or operable to support a means for obtaining a second TA according to an adjustment of the first TA using location information of the remote UE, measurement information of the remote UE, or both.

In some examples, the procedure is an early random-access procedure between the remote UE and the second network entity, and the random-access component 1240 is capable of, configured to, or operable to support a means for receiving, from the relay UE via the control message, a trigger to perform the early random-access procedure with the second network entity. In some examples, the procedure is an early random-access procedure between the remote UE and the second network entity, and the random-access component 1240 is capable of, configured to, or operable to support a means for transmitting, via a RACH resource and as part of the early random-access procedure, a first random-access message to the second network entity, where obtaining the TA information is in accordance with transmitting the first random-access message.

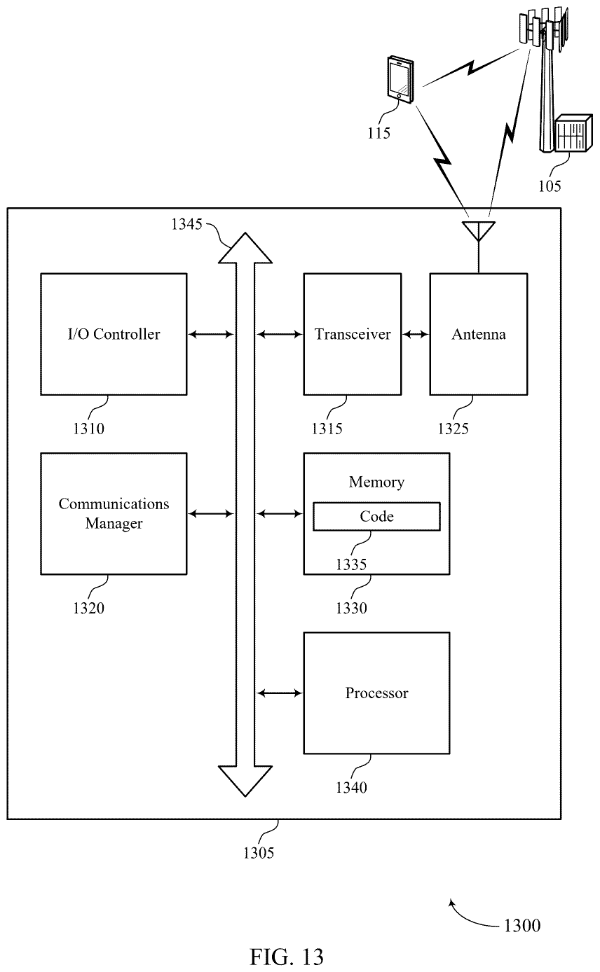

FIG. 13 shows a diagram of a system 1300 including a device 1305 that supports timing synchronization during handover procedures in wireless communications in accordance with one or more aspects of the present disclosure. The device 1305 may be an example of or include components of a device 1005, a device 1105, or a UE 115 as described herein. The device 1305 may communicate (e.g., wirelessly) with one or more other devices (e.g., network entities 105, UEs 115, or a combination thereof). The device 1305 may include components for bi-directional voice and data communications including components for transmitting and receiving communications, such as a communications manager 1320, an input/output (I/O) controller, such as an I/O controller 1310, a transceiver 1315, one or more antennas 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna. However, in some other cases, the device 1305 may have more than one antenna, which may be capable of concurrently transmitting or receiving multiple wireless transmissions. The transceiver 1315 may communicate bi-directionally via the one or more antennas 1325 using wired or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random-access memory (RAM) and read-only memory (ROM). The at least one memory 1330 may store computer-readable, computer-executable, or processor-executable code, such as the code 1335. The code 1335 may include instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may include, among other things, a basic I/O system (BIOS) which may control basic hardware or software operation such as the interaction with peripheral components or devices.

The at least one processor 1340 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting timing synchronization during handover procedures in wireless communications). For example, the device 1305 or a component of the device 1305 may include at least one processor 1340 and at least one memory 1330 coupled with or to the at least one processor 1340, the at least one processor 1340 and the at least one memory 1330 configured to perform various functions described herein.

In some examples, the at least one processor 1340 may include multiple processors and the at least one memory 1330 may include multiple memories. One or more of the multiple processors may be coupled with one or more of the multiple memories, which may, individually or collectively, be configured to perform various functions described herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code 1335 (e.g., processor-executable code) stored in the at least one memory 1330 or otherwise, to perform one or more of the functions described herein.

The communications manager 1320 may support wireless communications in accordance with examples as disclosed herein. For example, the communications manager 1320 is capable of, configured to, or operable to support a means for forwarding, from a first network entity to a remote UE in communication with the relay UE, a control message indicating that the remote UE is to perform a procedure with a second network entity. The communications manager 1320 is capable of, configured to, or operable to support a means for obtaining, in accordance with forwarding the control message to the remote UE, TA information used for communications between the second network entity and the remote UE. The communications manager 1320 is capable of, configured to, or operable to support a means for transmitting the TA information to the remote UE in accordance with obtaining the TA information.

Additionally, or alternatively, the communications manager 1320 may support wireless communications in accordance with examples as disclosed herein. For example, the communications manager 1320 is capable of, configured to, or operable to support a means for receiving, from a first network entity via a relay UE, a control message indicating that the remote UE is to perform a procedure with a second network entity. The communications manager 1320 is capable of, configured to, or operable to support a means for obtaining, in accordance with receiving the control message, TA information used for communications between the second network entity and the remote UE. The communications manager 1320 is capable of, configured to, or operable to support a means for communicating with the second network entity according to the TA information.

By including or configuring the communications manager 1320 in accordance with examples as described herein, the device 1305 may support techniques for improved communication reliability, reduced latency, and improved user experience.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of timing synchronization during handover procedures in wireless communications as described herein, or the at least one processor 1340 and the at least one memory 1330 may be otherwise configured to, individually or collectively, perform or support such operations.

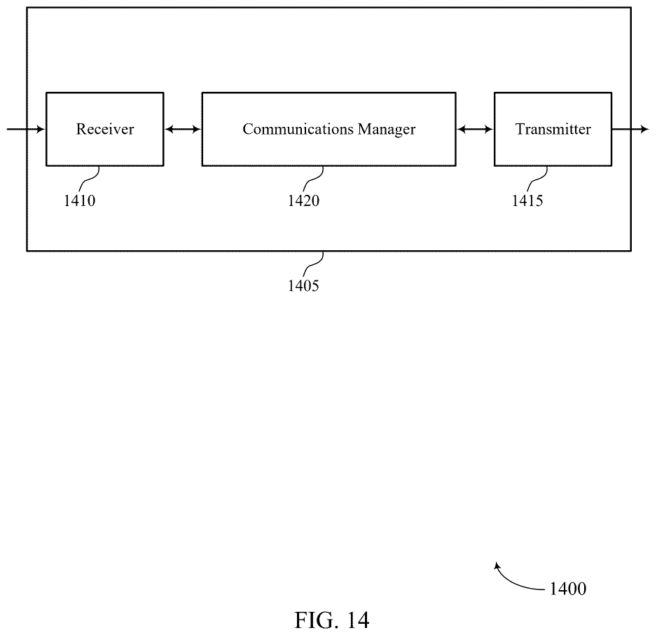

FIG. 14 shows a block diagram 1400 of a device 1405 that supports timing synchronization during handover procedures in wireless communications in accordance with one or more aspects of the present disclosure. The device 1405 may be an example of aspects of a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to, individually or collectively, support or enable the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations or components thereof may be examples of means for performing various aspects of timing synchronization during handover procedures in wireless communications as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor (e.g., referred to as a processor-executable code). If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. For example, the communications manager 1420 is capable of, configured to, or operable to support a means for receiving, from a second network entity, a request for a remote UE to perform a handover procedure to the first network entity, where the remote UE is in communication with the second network entity via a relay UE, and where the request includes an indication of the relay UE. The communications manager 1420 is capable of, configured to, or operable to support a means for transmitting, to the second network entity, a control message indicating that the remote UE is to perform the handover procedure to the first network entity without communicating a first random-access message and a second random-access message of a RACH procedure. The communications manager 1420 is capable of, configured to, or operable to support a means for communicating, in accordance with transmitting the control message, with the remote UE according to a TA value.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for more efficient utilization of communication resources.

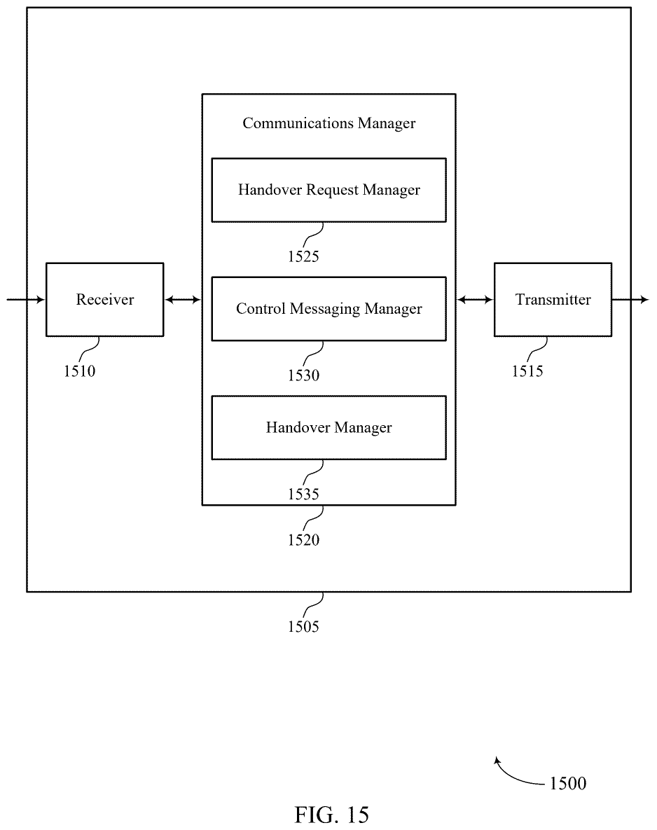

FIG. 15 shows a block diagram 1500 of a device 1505 that supports timing synchronization during handover procedures in wireless communications in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to support the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of timing synchronization during handover procedures in wireless communications as described herein. For example, the communications manager 1520 may include a handover request manager 1525, a control messaging manager 1530, a handover manager 1535, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. The handover request manager 1525 is capable of, configured to, or operable to support a means for receiving, from a second network entity, a request for a remote UE to perform a handover procedure to the first network entity, where the remote UE is in communication with the second network entity via a relay UE, and where the request includes an indication of the relay UE. The control messaging manager 1530 is capable of, configured to, or operable to support a means for transmitting, to the second network entity, a control message indicating that the remote UE is to perform the handover procedure to the first network entity without communicating a first random-access message and a second random-access message of a RACH procedure. The handover manager 1535 is capable of, configured to, or operable to support a means for communicating, in accordance with transmitting the control message, with the remote UE according to a TA value.

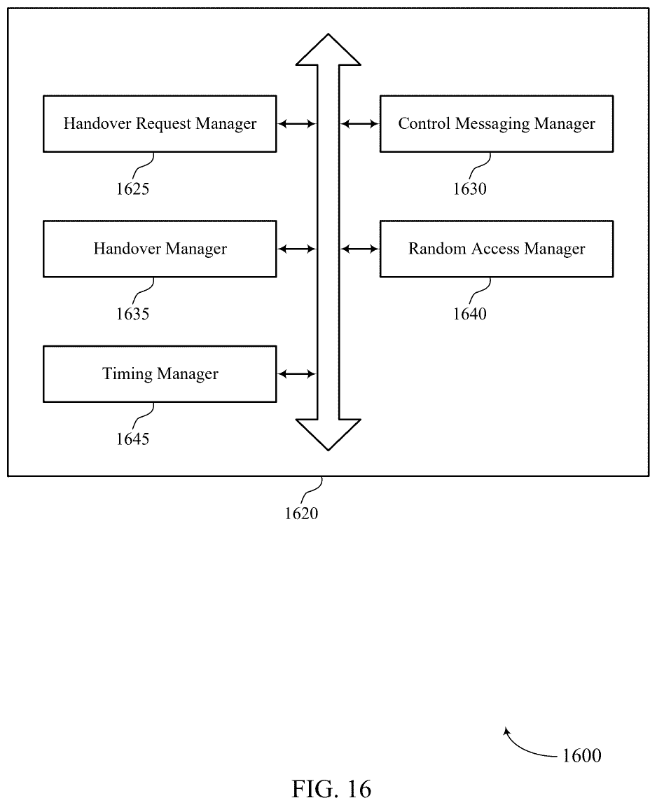

FIG. 16 shows a block diagram 1600 of a communications manager 1620 that supports timing synchronization during handover procedures in wireless communications in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of timing synchronization during handover procedures in wireless communications as described herein. For example, the communications manager 1620 may include a handover request manager 1625, a control messaging manager 1630, a handover manager 1635, a random-access manager 1640, a timing manager 1645, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications in accordance with examples as disclosed herein. The handover request manager 1625 is capable of, configured to, or operable to support a means for receiving, from a second network entity, a request for a remote UE to perform a handover procedure to the first network entity, where the remote UE is in communication with the second network entity via a relay UE, and where the request includes an indication of the relay UE. The control messaging manager 1630 is capable of, configured to, or operable to support a means for transmitting, to the second network entity, a control message indicating that the remote UE is to perform the handover procedure to the first network entity without communicating a first random-access message and a second random-access message of a RACH procedure. The handover manager 1635 is capable of, configured to, or operable to support a means for communicating, in accordance with transmitting the control message, with the remote UE according to a TA value.

In some examples, the random-access manager 1640 is capable of, configured to, or operable to support a means for receiving, via a RACH resource and as part of an early random-access procedure, a first random-access message from the remote UE, where receiving the request for the remote UE to perform the handover procedure is in accordance with receiving the first random-access message, and where the early random-access procedure is performed prior to the handover procedure. In some examples, the timing manager 1645 is capable of, configured to, or operable to support a means for transmitting, to the second network entity, the TA value, where the TA value is computed in accordance with receiving the first random-access message from the remote UE.

In some examples, the TA value is transmitted via the control message, or the TA value is transmitted in a second control message that is different from the control message.

In some examples, the random-access manager 1640 is capable of, configured to, or operable to support a means for receiving, via a RACH resource and as part of an early random-access procedure, a first random-access message from the remote UE. In some examples, the timing manager 1645 is capable of, configured to, or operable to support a means for transmitting, to the remote UE and as part of the early random-access procedure, the TA value, where the TA value is computed in accordance with receiving the first random-access message from the remote UE, where receiving the request for the remote UE to perform the handover procedure is in response to transmitting the TA value to the second network entity, and where the early random-access procedure is performed prior to the handover procedure.

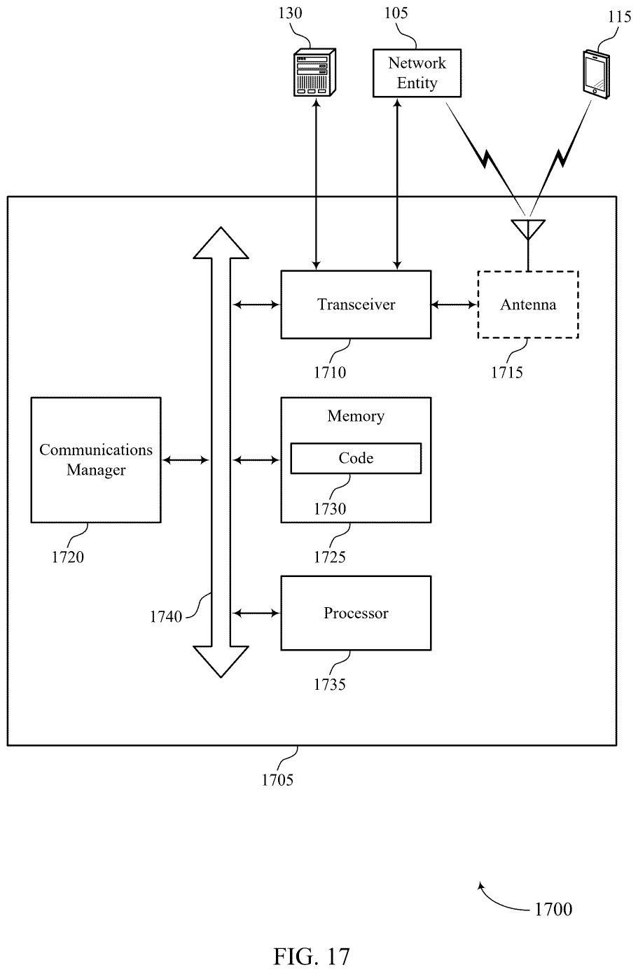

FIG. 17 shows a diagram of a system 1700 including a device 1705 that supports timing synchronization during handover procedures in wireless communications in accordance with one or more aspects of the present disclosure. The device 1705 may be an example of or include components of a device 1405, a device 1505, or a network entity 105 as described herein. The device 1705 may communicate with other network devices or network equipment such as one or more of the network entities 105, UEs 115, or any combination thereof. The communications may include communications over one or more wired interfaces, over one or more wireless interfaces, or any combination thereof. The device 1705 may include components that support outputting and obtaining communications, such as a communications manager 1720, a transceiver 1710, one or more antennas 1715, at least one memory 1725, code 1730, and at least one processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or one or more memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or one or more memory components (e.g., the at least one processor 1735, the at least one memory 1725, or both), may be included in a chip or chip assembly that is installed in the device 1705. In some examples, the transceiver 1710 may be operable to support communications via one or more communications links (e.g., communication link(s) 125, backhaul communication link(s) 120, a midhaul communication link 162, a fronthaul communication link 168).

The at least one memory 1725 may include RAM, ROM, or any combination thereof. The at least one memory 1725 may store computer-readable, computer-executable, or processor-executable code, such as the code 1730. The code 1730 may include instructions that, when executed by one or more of the at least one processor 1735, cause the device 1705 to perform various functions described herein. The code 1730 may be stored in a non-transitory computer-readable medium such as system memory or another type of memory. In some cases, the code 1730 may not be directly executable by a processor of the at least one processor 1735 but may cause a computer (e.g., when compiled and executed) to perform functions described herein. In some cases, the at least one memory 1725 may include, among other things, a BIOS which may control basic hardware or software operation such as the interaction with peripheral components or devices. In some examples, the at least one processor 1735 may include multiple processors and the at least one memory 1725 may include multiple memories. One or more of the multiple processors may be coupled with one or more of the multiple memories which may, individually or collectively, be configured to perform various functions herein (for example, as part of a processing system).

The at least one processor 1735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1735 may be configured to operate a memory array using a memory controller. In some other cases, a memory controller may be integrated into one or more of the at least one processor 1735. The at least one processor 1735 may be configured to execute computer-readable instructions stored in a memory (e.g., one or more of the at least one memory 1725) to cause the device 1705 to perform various functions (e.g., functions or tasks supporting timing synchronization during handover procedures in wireless communications). For example, the device 1705 or a component of the device 1705 may include at least one processor 1735 and at least one memory 1725 coupled with one or more of the at least one processor 1735, the at least one processor 1735 and the at least one memory 1725 configured to perform various functions described herein. The at least one processor 1735 may be an example of a cloud-computing platform (e.g., one or more physical nodes and supporting software such as operating systems, virtual machines, or container instances) that may host the functions (e.g., by executing code 1730) to perform the functions of the device 1705. The at least one processor 1735 may be any one or more suitable processors capable of executing scripts or instructions of one or more software programs stored in the device 1705 (such as within one or more of the at least one memory 1725).

In some examples, the at least one processor 1735 may include multiple processors and the at least one memory 1725 may include multiple memories. One or more of the multiple processors may be coupled with one or more of the multiple memories, which may, individually or collectively, be configured to perform various functions herein. In some examples, the at least one processor 1735 may be a component of a processing system, which may refer to a system (such as a series) of machines, circuitry (including, for example, one or both of processor circuitry (which may include the at least one processor 1735) and memory circuitry (which may include the at least one memory 1725)), or components, that receives or obtains inputs and processes the inputs to produce, generate, or obtain a set of outputs. The processing system may be configured to perform one or more of the functions described herein. For example, the at least one processor 1735 or a processing system including the at least one processor 1735 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code stored in the at least one memory 1725 or otherwise, to perform one or more of the functions described herein.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the at least one memory 1725, the code 1730, and the at least one processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with one or more other network entities 105, and may include a controller or scheduler for controlling communications with UEs 115 (e.g., in cooperation with the one or more other network devices). In some examples, the communications manager 1720 may support an X2 interface within an LTE/LTE-A wireless communications network technology to provide communication between network entities 105.

The communications manager 1720 may support wireless communications in accordance with examples as disclosed herein. For example, the communications manager 1720 is capable of, configured to, or operable to support a means for receiving, from a second network entity, a request for a remote UE to perform a handover procedure to the first network entity, where the remote UE is in communication with the second network entity via a relay UE, and where the request includes an indication of the relay UE. The communications manager 1720 is capable of, configured to, or operable to support a means for transmitting, to the second network entity, a control message indicating that the remote UE is to perform the handover procedure to the first network entity without communicating a first random-access message and a second random-access message of a RACH procedure. The communications manager 1720 is capable of, configured to, or operable to support a means for communicating, in accordance with transmitting the control message, with the remote UE according to a TA value.

By including or configuring the communications manager 1720 in accordance with examples as described herein, the device 1705 may support techniques for improved communication reliability, reduced latency, and improved user experience related to improved coordination between devices.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, one or more of the at least one processor 1735, one or more of the at least one memory 1725, the code 1730, or any combination thereof (for example, by a processing system including at least a portion of the at least one processor 1735, the at least one memory 1725, the code 1730, or any combination thereof). For example, the code 1730 may include instructions executable by one or more of the at least one processor 1735 to cause the device 1705 to perform various aspects of timing synchronization during handover procedures in wireless communications as described herein, or the at least one processor 1735 and the at least one memory 1725 may be otherwise configured to, individually or collectively, perform or support such operations.

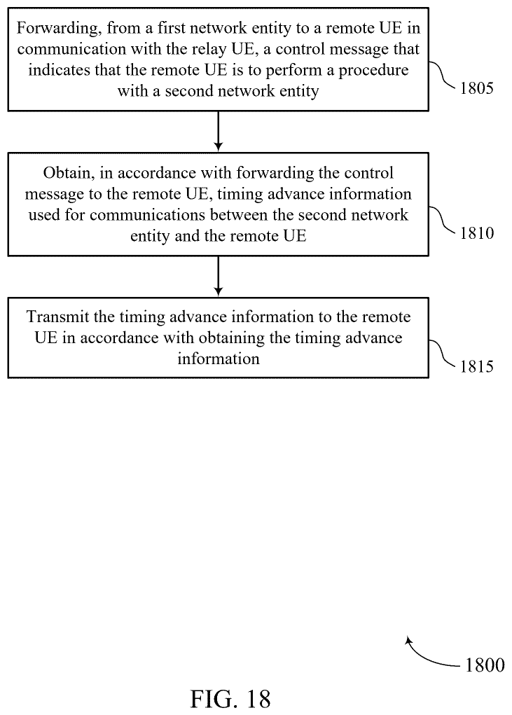

FIG. 18 shows a flowchart illustrating a method 1800 that supports timing synchronization during handover procedures in wireless communications in accordance with one or more aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include forwarding, from a first network entity to a remote UE in communication with the relay UE, a control message indicating that the remote UE is to perform a procedure with a second network entity. The operations of 1805 may be performed in accordance with examples as disclosed herein. In some examples, aspects of the operations of 1805 may be performed by a control messaging component 1225 as described with reference to FIG. 12.

At 1810, the method may include obtaining, in accordance with forwarding the control message to the remote UE, TA information used for communications between the second network entity and the remote UE. The operations of 1810 may be performed in accordance with examples as disclosed herein. In some examples, aspects of the operations of 1810 may be performed by a TA information component 1230 as described with reference to FIG. 12.

At 1815, the method may include transmitting the TA information to the remote UE in accordance with obtaining the TA information. The operations of 1815 may be performed in accordance with examples as disclosed herein. In some examples, aspects of the operations of 1815 may be performed by a TA information component 1230 as described with reference to FIG. 12.

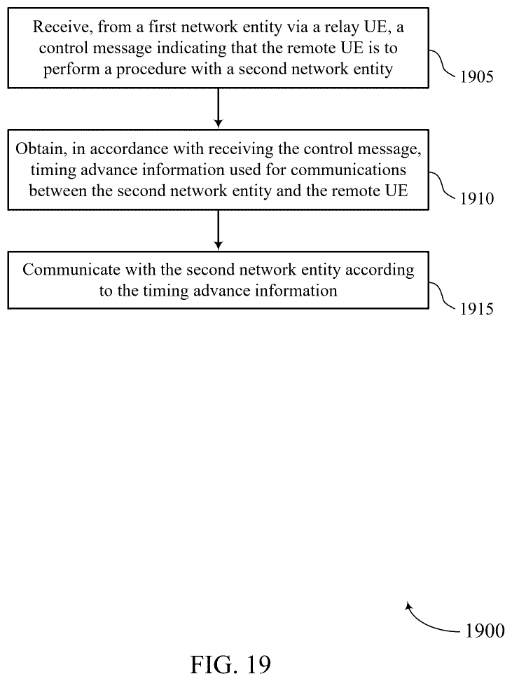

FIG. 19 shows a flowchart illustrating a method 1900 that supports timing synchronization during handover procedures in wireless communications in accordance with one or more aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1905, the method may include receiving, from a first network entity via a relay UE, a control message indicating that the remote UE is to perform a procedure with a second network entity. The operations of 1905 may be performed in accordance with examples as disclosed herein. In some examples, aspects of the operations of 1905 may be performed by a control messaging component 1225 as described with reference to FIG. 12.

At 1910, the method may include obtaining, in accordance with receiving the control message, TA information used for communications between the second network entity and the remote UE. The operations of 1910 may be performed in accordance with examples as disclosed herein. In some examples, aspects of the operations of 1910 may be performed by a TA information component 1230 as described with reference to FIG. 12.

At 1915, the method may include communicating with the second network entity according to the TA information. The operations of 1915 may be performed in accordance with examples as disclosed herein. In some examples, aspects of the operations of 1915 may be performed by a handover component 1235 as described with reference to FIG. 12.

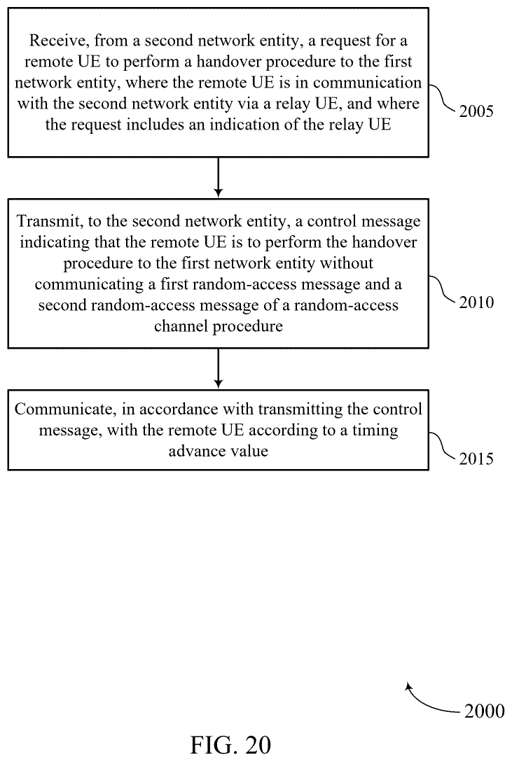

FIG. 20 shows a flowchart illustrating a method 2000 that supports timing synchronization during handover procedures in wireless communications in accordance with one or more aspects of the present disclosure. The operations of the method 2000 may be implemented by a network entity or its components as described herein. For example, the operations of the method 2000 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2005, the method may include receiving, from a second network entity, a request for a remote UE to perform a handover procedure to the first network entity, where the remote UE is in communication with the second network entity via a relay UE, and where the request includes an indication of the relay UE. The operations of 2005 may be performed in accordance with examples as disclosed herein. In some examples, aspects of the operations of 2005 may be performed by a handover request manager 1625 as described with reference to FIG. 16.

At 2010, the method may include transmitting, to the second network entity, a control message indicating that the remote UE is to perform the handover procedure to the first network entity without communicating a first random-access message and a second random-access message of a RACH procedure. The operations of 2010 may be performed in accordance with examples as disclosed herein. In some examples, aspects of the operations of 2010 may be performed by a control messaging manager 1630 as described with reference to FIG. 16.

At 2015, the method may include communicating, in accordance with transmitting the control message, with the remote UE according to a TA value. The operations of 2015 may be performed in accordance with examples as disclosed herein. In some examples, aspects of the operations of 2015 may be performed by a handover manager 1635 as described with reference to FIG. 16.

The following provides an overview of aspects of the present disclosure:
Aspect 1: A method for wireless communications at a relay UE, comprising: forwarding, from a first network entity to a remote UE in communication with the relay UE, a control message indicating that the remote UE is to perform a procedure with a second network entity; obtaining, in accordance with forwarding the control message to the remote UE, TA information used for communications between the second network entity and the remote UE; and transmitting the TA information to the remote UE in accordance with obtaining the TA information.

Aspect 2: The method of aspect 1, wherein the procedure is a handover procedure, and the control message further indicates that the remote UE is to perform the handover procedure to the second network entity without communicating a first random-access message and a second random-access message of a RACH procedure.

Aspect 3: The method of aspect 2, wherein obtaining the TA information comprises: computing a first TA value associated with communications between the relay UE and the second network entity, wherein the TA information comprises an indication of the first TA value, location information associated with the relay UE, or both.

Aspect 4: The method of aspect 3, further comprising: receiving one or more first reference signals from the first network entity; and receiving one or more second reference signals from the second network entity, wherein computing the first TA value is in accordance with the one or more first reference signals, the one or more second reference signals, a second TA value associated with communications between the relay UE and the first network entity, or any combination thereof.

Aspect 5: The method of any of aspects 3 through 4, further comprising: obtaining a second TA value associated with communications between the remote UE and the second network entity in accordance with an adjustment of the first TA value using the location information of the remote UE, measurement information of the remote UE, or both, wherein the TA information comprises the second TA value.

Aspect 6: The method of aspect 5, further comprising: receiving assistance information from the remote UE, wherein the assistance information comprises the location information of the remote UE, the measurement information of the remote UE, or both.

Aspect 7: The method of any of aspects 2 through 6, further comprising: obtaining a first TA value used for communications between the relay UE and the second network entity, wherein the TA information comprises the first TA value.

Aspect 8: The method of aspect 7, wherein the first TA value is obtained from the first network entity, obtained from the second network entity, obtained in accordance with communication of a first message from the relay UE to the second network entity, or any combination thereof.

Aspect 9: The method of any of aspects 2 through 8, wherein the TA information comprises a first reception time at the relay UE of a first reference signal from the first network entity, a second reception time at the relay UE of a second reference signal from the second network entity, a first TA value used for communications between the relay UE and the first network entity, location information of the relay UE, or any combination thereof.

Aspect 10: The method of any of aspects 1 through 9, wherein the procedure is an early random-access procedure between the remote UE and the second network entity, and wherein forwarding the control message comprises: receiving, from the first network entity, a trigger for the remote UE to perform the early random-access procedure with the second network entity; and transmitting, to the remote UE, the trigger for the remote UE to perform the early random-access procedure with the second network entity, wherein obtaining the TA information is in accordance with transmitting the trigger for the remote UE to perform the early random-access procedure.

Aspect 11: The method of aspect 10, wherein the TA information comprises a first TA between the remote UE and the second network entity, and wherein obtaining the TA information comprises: receiving, from the first network entity, an indication of the TA information, wherein transmitting the TA information is in accordance with receiving the indication.

Aspect 12: A method for wireless communications at a remote UE, comprising: receiving, from a first network entity via a relay UE, a control message indicating that the remote UE is to perform a procedure with a second network entity; obtaining, in accordance with receiving the control message, TA information used for communications between the second network entity and the remote UE; and communicating with the second network entity according to the TA information.

Aspect 13: The method of aspect 12, wherein the procedure is a handover procedure, and the control message further indicates that the remote UE is to perform the handover procedure to the second network entity without communicating a first random-access message and a second random-access message of a RACH procedure.

Aspect 14: The method of aspect 13, wherein the TA information comprises a first reception time at the relay UE of a first reference signal from the first network entity, a second reception time at the relay UE of a second reference signal from the second network entity, a first TA value used for communications between the relay UE and the first network entity, location information of the relay UE, or any combination thereof, and wherein the method further comprises: computing a TA value used for communications between the remote UE and the second network entity using the TA information.

Aspect 15: The method of any of aspects 13 through 14, wherein the TA information comprises a first TA used for communications between the relay UE and the second network entity, and wherein the method further comprises: obtaining a second TA according to an adjustment of the first TA using location information of the remote UE, measurement information of the remote UE, or both.

Aspect 16: The method of any of aspects 12 through 15, wherein the procedure is an early random-access procedure between the remote UE and the second network entity, and wherein the method further comprises: receiving, from the relay UE via the control message, a trigger to perform the early random-access procedure with the second network entity; and transmitting, via a RACH resource and as part of the early random-access procedure, a first random-access message to the second network entity, wherein obtaining the TA information is in accordance with transmitting the first random-access message.

Aspect 17: A method for wireless communications at a first network entity, comprising: receiving, from a second network entity, a request for a remote UE to perform a handover procedure to the first network entity, wherein the remote UE is in communication with the second network entity via a relay UE, and wherein the request comprises an indication of the relay UE; transmitting, to the second network entity, a control message indicating that the remote UE is to perform the handover procedure to the first network entity without communicating a first random-access message and a second random-access message of a RACH procedure; and communicating, in accordance with transmitting the control message, with the remote UE according to a TA value.

Aspect 18: The method of aspect 17, further comprising: receiving, via a RACH resource and as part of an early random-access procedure, a first random-access message from the remote UE, wherein receiving the request for the remote UE to perform the handover procedure is in accordance with receiving the first random-access message, and wherein the early random-access procedure is performed prior to the handover procedure; and transmitting, to the second network entity, the TA value, wherein the TA value is computed in accordance with receiving the first random-access message from the remote UE.

Aspect 19: The method of aspect 18, wherein the TA value is transmitted via the control message, or the TA value is transmitted in a second control message that is different from the control message.

Aspect 20: The method of any of aspects 17 through 19, further comprising: receiving, via a RACH resource and as part of an early random-access procedure, a first random-access message from the remote UE; and transmitting, to the remote UE and as part of the early random-access procedure, the TA value, wherein the TA value is computed in accordance with receiving the first random-access message from the remote UE, wherein receiving the request for the remote UE to perform the handover procedure is in response to transmitting the TA value to the second network entity, and wherein the early random-access procedure is performed prior to the handover procedure.

Aspect 21: A relay UE for wireless communications, comprising one or more memories storing processor-executable code, and one or more processors coupled with the one or more memories and individually or collectively operable to execute the code to cause the relay UE to perform a method of any of aspects 1 through 11.

Aspect 22: A relay UE for wireless communications, comprising at least one means for performing a method of any of aspects 1 through 11.

Aspect 23: A non-transitory computer-readable medium storing code for wireless communications, the code comprising instructions executable by one or more processors to perform a method of any of aspects 1 through 11.

Aspect 24: A remote UE for wireless communications, comprising one or more memories storing processor-executable code, and one or more processors coupled with the one or more memories and individually or collectively operable to execute the code to cause the remote UE to perform a method of any of aspects 12 through 16.

Aspect 25: A remote UE for wireless communications, comprising at least one means for performing a method of any of aspects 12 through 16.

Aspect 26: A non-transitory computer-readable medium storing code for wireless communications, the code comprising instructions executable by one or more processors to perform a method of any of aspects 12 through 16.

Aspect 27: A first network entity for wireless communications, comprising one or more memories storing processor-executable code, and one or more processors coupled with the one or more memories and individually or collectively operable to execute the code to cause the first network entity to perform a method of any of aspects 17 through 20.

Aspect 28: A first network entity for wireless communications, comprising at least one means for performing a method of any of aspects 17 through 20.

Aspect 29: A non-transitory computer-readable medium storing code for wireless communications, the code comprising instructions executable by one or more processors to perform a method of any of aspects 17 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A relay user equipment (UE), comprising:
one or more memories storing processor-executable code; and
one or more processors coupled with the one or more memories and individually or collectively operable to execute the code to cause the relay UE to:
forward, from a first network entity to a remote UE in communication with the relay UE, a control message that indicates that the remote UE is to perform a procedure with a second network entity;
obtain, in accordance with forwarding the control message to the remote UE, timing advance information used for communications between the second network entity and the remote UE; and
transmit the timing advance information to the remote UE in accordance with obtaining the timing advance information.

2. The relay UE of claim 1, wherein:
the procedure is a handover procedure, and
the control message further indicates that the remote UE is to perform the handover procedure to the second network entity without communicating a first random-access message and a second random-access message of a random-access channel procedure.

3. The relay UE of claim 2, wherein, to obtain the timing advance information, the one or more processors are individually or collectively operable to execute the code to cause the relay UE to:
compute a first timing advance value associated with communications between the relay UE and the second network entity, wherein the timing advance information comprises an indication of the first timing advance value, location information associated with the relay UE, or both.

4. The relay UE of claim 3, wherein the one or more processors are individually or collectively further operable to execute the code to cause the relay UE to:
receive one or more first reference signals from the first network entity; and
receive one or more second reference signals from the second network entity, wherein computing the first timing advance value is in accordance with the one or more first reference signals, the one or more second reference signals, a second timing advance value associated with communications between the relay UE and the first network entity, or any combination thereof.

5. The relay UE of claim 3, wherein the one or more processors are individually or collectively further operable to execute the code to cause the relay UE to:
obtain a second timing advance value associated with communications between the remote UE and the second network entity in accordance with an adjustment of the first timing advance value using the location information of the remote UE, measurement information of the remote UE, or both, wherein the timing advance information comprises the second timing advance value.

6. The relay UE of claim 5, wherein the one or more processors are individually or collectively further operable to execute the code to cause the relay UE to:
receive assistance information from the remote UE, wherein the assistance information comprises the location information of the remote UE, the measurement information of the remote UE, or both.

7. The relay UE of claim 2, wherein the one or more processors are individually or collectively further operable to execute the code to cause the relay UE to:
obtain a first timing advance value used for communications between the relay UE and the second network entity, wherein the timing advance information comprises the first timing advance value.

8. The relay UE of claim 7, wherein the first timing advance value is obtained from the first network entity, obtained from the second network entity, obtained in accordance with communication of a first message from the relay UE to the second network entity, or any combination thereof.

9. The relay UE of claim 2, wherein the timing advance information comprises a first reception time at the relay UE of a first reference signal from the first network entity, a second reception time at the relay UE of a second reference signal from the second network entity, a first timing advance value used for communications between the relay UE and the first network entity, location information of the relay UE, or any combination thereof.

10. The relay UE of claim 1, wherein, the procedure is an early random-access procedure between the remote UE and the second network entity, and wherein, to forward the control message, the one or more processors are individually or collectively operable to execute the code to cause the relay UE to:
receive, from the first network entity, a trigger for the remote UE to perform the early random-access procedure with the second network entity; and
transmit, to the remote UE, the trigger for the remote UE to perform the early random-access procedure with the second network entity, wherein obtaining the timing advance information is in accordance with transmitting the trigger for the remote UE to perform the early random-access procedure.

11. The relay UE of claim 10, wherein, the timing advance information comprises a first timing advance between the remote UE and the second network entity, and wherein, to obtain the timing advance information, the one or more processors are individually or collectively operable to execute the code to cause the relay UE to:
receive, from the first network entity, an indication of the timing advance information, wherein transmitting the timing advance information is in accordance with receiving the indication.

12. A remote user equipment (UE), comprising:
one or more memories storing processor-executable code; and
one or more processors coupled with the one or more memories and individually or collectively operable to execute the code to cause the remote UE to:
receive, from a first network entity via a relay UE, a control message that indicates that the remote UE is to perform a procedure with a second network entity;
obtain, in accordance with receiving the control message, timing advance information used for communications between the second network entity and the remote UE; and
communicate with the second network entity according to the timing advance information.

13. The remote UE of claim 12, wherein:
the procedure is a handover procedure, and
the control message further indicates that the remote UE is to perform the handover procedure to the second network entity without communicating a first random-access message and a second random-access message of a random-access channel procedure.

14. The remote UE of claim 13, wherein the timing advance information comprises a first reception time at the relay UE of a first reference signal from the first network entity, a second reception time at the relay UE of a second reference signal from the second network entity, a first timing advance value used for communications between the relay UE and the first network entity, location information of the relay UE, or any combination thereof, and the one or more processors are individually or collectively further operable to execute the code to cause the remote UE to:
compute a timing advance value used for communications between the remote UE and the second network entity using the timing advance information.

15. The remote UE of claim 13, wherein the timing advance information comprises a first timing advance used for communications between the relay UE and the second network entity, and the one or more processors are individually or collectively further operable to execute the code to cause the remote UE to:
obtain a second timing advance according to an adjustment of the first timing advance using location information of the remote UE, measurement information of the remote UE, or both.

16. The remote UE of claim 12, wherein the procedure is an early random-access procedure between the remote UE and the second network entity, and the one or more processors are individually or collectively further operable to execute the code to cause the remote UE to:
receive, from the relay UE via the control message, a trigger to perform the early random-access procedure with the second network entity; and
transmit, via a random-access channel resource and as part of the early random-access procedure, a first random-access message to the second network entity, wherein obtaining the timing advance information is in accordance with transmitting the first random-access message.

17. A first network entity, comprising:
one or more memories storing processor-executable code; and
one or more processors coupled with the one or more memories and individually or collectively operable to execute the code to cause the first network entity to:
receive, from a second network entity, a request for a remote user equipment (UE) to perform a handover procedure to the first network entity, wherein the remote UE is in communication with the second network entity via a relay UE, and wherein the request comprises an indication of the relay UE;
transmit, to the second network entity, a control message indicating that the remote UE is to perform the handover procedure to the first network entity without communicating a first random-access message and a second random-access message of a random-access channel procedure; and
communicate, in accordance with transmitting the control message, with the remote UE according to a timing advance value.

18. The first network entity of claim 17, wherein the one or more processors are individually or collectively further operable to execute the code to cause the first network entity to:
receive, via a random-access channel resource and as part of an early random-access procedure, a random-access message from the remote UE, wherein receiving the request for the remote UE to perform the handover procedure is in accordance with receiving the random-access message, and wherein the early random-access procedure is performed prior to the handover procedure; and
transmit, to the second network entity, the timing advance value, wherein the timing advance value is computed in accordance with receiving the random-access message from the remote UE.

19. The first network entity of claim 18, wherein the timing advance value is transmitted via the control message, or the timing advance value is transmitted in a second control message that is different from the control message.

20. The first network entity of claim 17, wherein the one or more processors are individually or collectively further operable to execute the code to cause the first network entity to:
receive, via a random-access channel resource and as part of an early random-access procedure, a random-access message from the remote UE; and
transmit, to the remote UE and as part of the early random-access procedure, the timing advance value, wherein the timing advance value is computed in accordance with receiving the random-access message from the remote UE, wherein receiving the request for the remote UE to perform the handover procedure is in response to transmitting the timing advance value to the second network entity, and wherein the early random-access procedure is performed prior to the handover procedure.
